(19) United States
(12) Patent Application Publication
(10) Pub. No.: US 2026/0264256 A1
(43) Pub. Date: Sep. 10, 2026

(54) ROBOT

(71) Applicant: SEIKO EPSON CORPORATION, TOKYO (JP)

(72) Inventor: Takayuki KONDO, CHINO-SHI (JP)

(21) Appl. No.: 19/560,333

(22) Filed: Mar. 9, 2026

(30) Foreign Application Priority Data
Mar. 7, 2025 (JP) 2025-035961

(51) Int. Cl. B25J 9/16; B25J 9/10; B25J 19/02

(52) U.S. Cl. CPC B25J 9/1697; B25J 9/1005; B25J 9/162; B25J 9/1664; B25J 19/023

(57) ABSTRACT

A robot includes a base, a first arm coupled to the base and configured to rotate around a first rotation shaft, a second arm coupled to one end portion of the first arm and configured to rotate around a second rotation shaft parallel to the first rotation shaft with respect to the first arm, a marker attached to the second arm in order to determine a control point of the robot, a first camera, a position and a posture of which are fixed with respect to the base, the first camera being disposed at a position where the first camera can image the marker that moves on a virtual plane orthogonal to the first rotation shaft and imaging the first arm and the second arm at a fixed time interval, and a control unit configured to control, every time the first camera acquires an image, based on differences between coordinate values of the control point of the robot determined from the marker in the image and coordinate values of a designated target point, a first motor that rotates the first rotation shaft and a second motor that rotates the second rotation shaft.

The present application is based on, and claims priority from JP Application Serial Number 2025-035961, filed Mar. 7, 2025, the disclosure of which is hereby incorporated by reference herein in its entirety.

### BACKGROUND

### 1. Technical Field

The present disclosure relates to a robot.

### 2. Related Art

In a robot vision system described in JP-A-2010-172986, a computer executes three-dimensional measurement and recognition processing based on an image acquired by a stereo camera and a robot controller controls a robot based on target coordinates calculated by the computer. In a technique described in JP-A-2010-172986, calibration is executed prior to an operation of the robot.

JP-A-2010-172986 is an example of the related art.

In the technique described in JP-A-2010-172986, it is necessary to perform processing of calculating a three-dimensional position in a stereo camera coordinate system of a target based on an image obtained by imaging the target and converting the three-dimensional position in the stereo camera coordinate system into a three-dimensional position in a robot coordinate system. Therefore, a processing load is large. Further, it is also necessary to execute calibration in order to calculate parameters for executing coordinate conversion from the stereo camera coordinate system into the robot coordinate system. For this reason, there is a demand for further improvement in a technique for reducing a processing load of robot control.

### SUMMARY

The present disclosure can be implemented as aspects explained below.

According to an aspect of the present disclosure, a robot is provided. The robot includes: a base; a first arm coupled to the base and configured to rotate around a first rotation shaft; a second arm coupled to one end portion of the first arm and configured to rotate around a second rotation shaft parallel to the first rotation shaft with respect to the first arm; at least one physical marker attached to the second arm in order to determine a control point of the robot; a first camera, a position and a posture of which are fixed with respect to the base, the first camera being disposed at a position where, when a virtual plane orthogonal to the first rotation shaft is assumed, the first camera can image the marker that moves on the virtual plane and imaging the first arm and the second arm at a fixed time interval; and a control unit configured to determine, every time the first camera acquires an image, based on differences between coordinate values of the control point of the robot determined from the marker in the image captured by the first camera and coordinate values of a designated target point, a displacement amount of rotation of a first motor that rotates the first arm around the first rotation shaft and a displacement amount of rotation of a second motor that rotates the second arm around the second rotation shaft and control the first motor and the second motor to rotate with the determined displacement amounts.

According to another aspect of the present disclosure, a robot is provided. The robot is a robot configured as a Cartesian coordinate robot and includes: at least one physical marker representing a position of a control point of the robot; a first slider configured to linearly move the control point along an X axis; a second slider configured to linearly move the control point along a Y axis orthogonal to the X axis; a first camera, a position and a posture of which are fixed with respect to the first slider and the second slider, the first camera being disposed at a position where, when a virtual plane parallel to the X axis and the Y axis is assumed, the first camera images the control point that moves on the virtual plane and imaging the first slider and the second slider at a fixed time interval; and a control unit configured to cause the first slider and the second slider to respectively operate to reduce differences between coordinate values of the control point of the robot and coordinate values representing a designated target point in an image captured by the first camera.

### BRIEF DESCRIPTION OF THE DRAWINGS

FIG. 1 is a diagram illustrating a schematic configuration of a robot system according to a first embodiment.

FIG. 2 is a diagram illustrating a mechanism for connecting a first arm and a second arm.

FIG. 3 is a diagram illustrating an example of an image captured by a camera.

FIG. 4 is a former half of a flowchart illustrating processing of generating a trajectory of an arm.

FIG. 5 is a latter half of the flowchart illustrating the processing of generating the trajectory of the arm.

FIG. 6 is a diagram illustrating an example of a rotation amount table on an X axis.

FIG. 7 is a diagram illustrating an aspect in which a base of a robot is fixed to a wall.

FIG. 8 is a diagram illustrating an image obtained by imaging a Cartesian coordinate robot.

FIG. 9 is a diagram illustrating a schematic configuration of a robot system according to a second embodiment.

FIG. 10 is a diagram illustrating an example of an image captured by a camera.

FIG. 11 is a diagram illustrating a schematic configuration of a robot system according to a modification of the second embodiment.

FIG. 12 is a diagram illustrating an example of an image captured by a camera.

FIG. 13 is a diagram of an image obtained by imaging a state in which guide light is emitted.

FIG. 14 is a diagram illustrating a sensor provided at the distal end portion of an arm.

FIG. 15 is a diagram illustrating a schematic configuration of a robot system according to a third embodiment.

FIG. 16 is a diagram illustrating a schematic configuration of a robot system according to a fourth embodiment.

FIG. 17 is a diagram illustrating a schematic configuration of a robot system according to a modification of the fourth embodiment.

FIG. 18 is a diagram illustrating a schematic configuration of a robot system according to a fifth embodiment.

FIG. 19 is a diagram illustrating an example of an image captured by the camera.

FIG. 20 is a diagram illustrating an algorithm for detecting a light emitting section.

FIG. 21 is a diagram illustrating an example of an image obtained by imaging a robot according to a sixth embodiment.

FIG. 22 is a flowchart of processing of specifying initial positions of two marks.

FIG. 23 is a diagram illustrating an example of an image captured by the camera in a seventh embodiment.

FIG. 24 is a diagram illustrating a state of returning to a return point.

FIG. 25 is a diagram illustrating a schematic configuration of a robot system according to an eighth embodiment.

FIG. 26 is a diagram illustrating an example of an operation UI displayed on a terminal device.

FIG. 27 is a diagram illustrating another example of the operation UI displayed on the terminal device.

### DESCRIPTION OF EMBODIMENTS

### A. FIRST EMBODIMENT

### A1. Basic Configuration

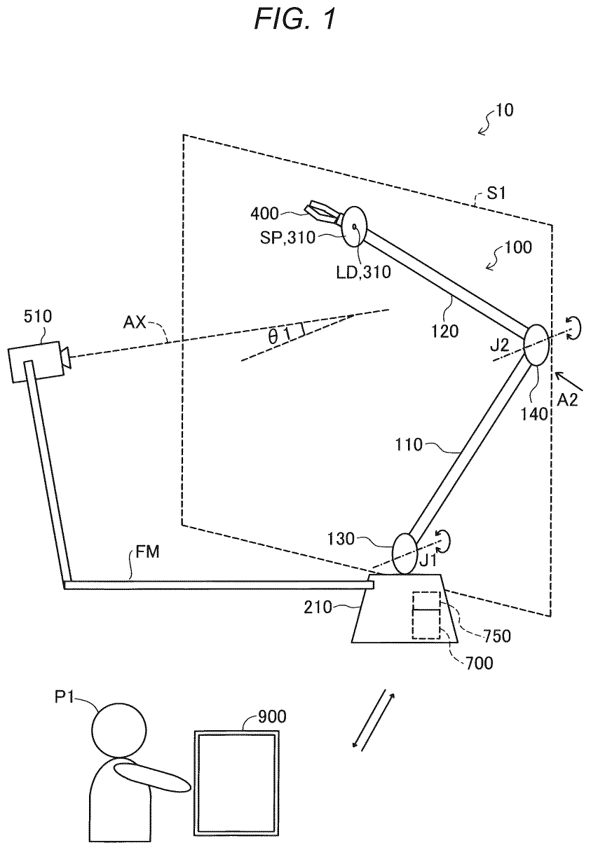

FIG. 1 is a diagram illustrating a schematic configuration of a robot system 10 according to a first embodiment. As illustrated in FIG. 1, the robot system 10 includes a robot 100, a control unit 700, a relay unit 750, and a terminal device 900.

The robot 100 includes a first arm 110, a second arm 120, a joint section 130, a joint section 140, a base 210 that supports the first arm 110 and the second arm 120, a mark 310, an end effector 400, and a camera 510. Although not illustrated in FIG. 1, the robot 100 further includes a drive mechanism D1, a drive mechanism D2, and a link mechanism L1. The mark 310 is also referred to as “marker”.

One end portion of the first arm 110 is coupled to the base 210 via the joint section 130. The other end portion of the first arm 110 is coupled to one end portion of the second arm 120 via the joint section 140. The first arm 110 and the second arm 120 are manufactured from, for example, a rod-shaped member made of resin.

The joint section 130 connects the base 210 and the first arm 110. The joint section 130 includes a rotation shaft J1. The joint section 130 can rotate the first arm 110 around the rotation shaft J1. The rotation shaft J1 is also referred to as “first rotation shaft”. The rotation shaft J1 rotates, whereby the first arm 110 rotates with respect to the base 210.

The joint section 140 connects the first arm 110 and the second arm 120. The joint section 140 includes a rotation shaft J2. The joint section 140 can rotate the second arm 120 around the rotation shaft J2. The rotation shaft J2 of the joint section 140 is also referred to as “second rotation shaft”. The rotation shaft J2 rotates, whereby the second arm 120 rotates with respect to the first arm 110.

The rotation shaft J1 of the joint section 130 and the rotation shaft J2 of the joint section 140 are parallel to each other. Preferably, the rotation shaft J1 and the rotation shaft J2 are parallel to the horizontal plane. Here, “parallel” includes not only a state in which the rotation shaft J1 and the rotation shaft J2 are strictly parallel to the horizontal plane but also a state in which the rotation shaft J1 and the rotation shaft J2 are substantially parallel to the horizontal plane. The rotation shaft J1 and the rotation shaft J2 being substantially parallel to the horizontal plane means that, when the rotation shaft J1 and the rotation shaft J2 are projected onto a plane perpendicular to the horizontal plane, an angle formed by the rotation shaft J1 and the rotation shaft J2 with respect to the horizontal plane is in a range of −10 degrees to 10 degrees.

The mark 310 is attached to the vicinity of the end portion of the second arm 120 opposite to the end portion on the side coupled to the first arm 110. The mark 310 is provided in order to specify the position of a control point of the robot 100 in an image captured by the camera 510. For example, any position is set in the end effector 400 as the control point. In the present embodiment, it is assumed that the mark 310 is disposed at a position close to the control point of the robot 100 to the extent that the position of the mark 310 can be regarded the same as the position of the control point.

The mark 310 includes a light emitting section LD and a light blocking plate SP disposed around the light emitting section LD. The light emitting section LD includes at least one point light source LED (Light Emitting Diode). The light blocking plate SP is desirably manufactured from a plate-shaped member made of resin having low reflectance. The light blocking plate SP is, for example, black. The light blocking plate SP is provided in order to block light emitted from a light source present on a side opposite to a side where the camera 510 is present with respect to the light emitting section LD. Since the light blocking plate SP is disposed around the light emitting section LD, the control unit 700 is prevented from erroneously recognizing light present behind the light emitting section LD in the captured image as light emitted by the light emitting section LD. Thus, the control unit 700 can easily specify the position of the mark 310 in the image captured by the camera 510.

The end effector 400 is attached to the end portion of the second arm 120. The end effector 400 is, for example, a gripper that grips a target. The gripper serving as the end effector 400 performs a gripping operation or a releasing operation according to control of the control unit 700. The end effector 400 is also referred to as “gripping unit”.

The camera 510 is fixed to the base 210 by a fixing member FM. For this reason, the position and the posture of the camera 510 are fixed with respect to the base 210. The camera 510 is disposed at a position where the camera 510 can image at least the mark 310 and a target point. The target point is a position that the control point of the robot 100 should reach. The target point may be a reaching point that the control point of the robot 100 should finally reach or may be a passing point that the control point of the robot 100 should pass before reaching the final reaching point. The camera 510 images the robot 100 at a constant frame rate. As the camera 510, for example, a board camera in which a lens is directly mounted on an image sensor substrate can be used. The camera 510 directly outputs the captured image to the control unit 700. The camera 510 is also referred to as “first camera”.

The control unit 700 controls an operation of the robot 100. Further, the control unit 700 controls an operation of the end effector 400. The control unit 700 includes a field programmable gate array (FPGA). The control unit 700 may include an application specific integrated circuit (ASIC) or a personal computer (PC). The control unit 700 includes, for example, an image input circuit to which an image output from the camera 510 is input, an image processing circuit that processes the image, a data relay circuit for communicating with other equipment, and an image output circuit that outputs the image to the terminal device 900 or the like via wireless communication such as Wi-Fi or the Internet communication network. The data relay circuit is used for, for example, wireless communication such as Wi-Fi (registered trademark) or communication via the Internet communication network.

In the present embodiment, the control unit 700 controls the operation of the robot 100 using so-called visual servoing based on information concerning the image acquired by the camera 510. The visual servoing is a technique for controlling a robot such that an image acquired by a camera coincides with a target image. In the present embodiment, an image in which a control point of the robot in the image acquired by the camera coincides with a designated target point is the target image.

Here, an imaginary plane S1, which is a virtual plane orthogonal to the rotation shaft J1, is assumed. Since the rotation shaft J1 of the joint section 130 and the rotation shaft J2 of the joint section 140 are parallel to each other, the rotation shaft J2 is also orthogonal to the imaginary plane S1. In order to facilitate understanding of the technique, the imaginary plane S1 is set in a limited range in which the mark 310 is assumed to move. At least one of the joint section 130 and the joint section 140 rotates, whereby the mark 310 attached to the second arm 120 moves on the imaginary plane S1. The position of the mark 310 can be represented by coordinates on the imaginary plane S1.

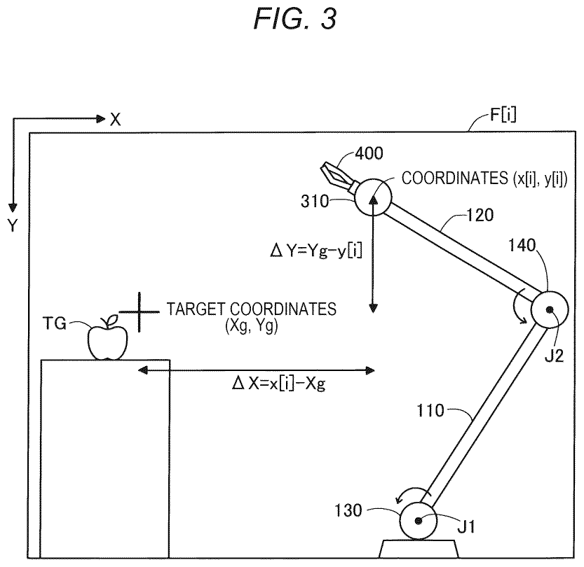

FIG. 3 is a diagram illustrating an example of an image F[i] captured by the camera 510. A subscript i is a positive integer that is added up every time imaging is executed. For example, coordinates of a pixel at the upper left corner of the image F[i] are set as a coordinate origin of the image F[i]. The right direction of the image F[i] is set as a positive direction of the X axis and the downward direction of the image F[i] is set as a positive direction of the Y axis. In the present embodiment, the position of the mark 310 on the imaginary plane S1 is specified by the position of the mark 310 in an image coordinate system representing a position on the image F[i] captured by the camera 510. As illustrated in FIG. 1, when an optical axis AX of the camera 510 does not coincide with a perpendicular PL of the imaginary plane S1, coordinates in the image F[i] captured by the camera 510 do not strictly coincide with coordinates in the imaginary plane S1. However, the position and the posture of the camera 510 are fixed with respect to the base 210 and, even if the coordinates in the imaginary plane S1 are specified based on the coordinates in the image F[i] captured by the camera 510, this does not cause a significant problem. However, an angle θ1 formed by the optical axis AX of the camera 510 with respect to the perpendicular PL of the imaginary plane S1 is preferably small. Specifically, the angle θ1 is preferably equal to or smaller than 60 degrees.

The control unit 700 calculates coordinates of the mark 310 on the image acquired by the camera 510 and controls the operation of the robot 100 based on coordinates representing a current position of the mark 310 and coordinates of the target point. In FIG. 3, the coordinates of the target point are described as target coordinates. In order to bring the coordinates of the mark 310 close to the coordinates of the target point in the image F[i] captured by the camera 510, for example, the control unit 700 executes control of repeatedly rotating the first arm 110 to reduce the difference between an X coordinate of the mark 310 and an X coordinate of the target point and rotating the second arm 120 to reduce the difference between a Y coordinate of the mark 310 and a Y coordinate of the target point.

The relay unit 750 is capable of communicating with the control unit 700 by wired communication or wireless communication. As the relay unit 750, for example, a Wi-Fi router can be used. The relay unit 750 transmits an image received from the control unit 700 to the terminal device 900. An aspect in which the relay unit 750 is used is an example. The control unit 700 and the terminal device 900 may directly perform wireless communication. The same applies to embodiments explained below.

The terminal device 900 is a smartphone or a tablet including a touch panel display. The terminal device 900 may be a PC including a mouse serving as an input device and a display serving as a display device. Hereinafter, the touch panel display and the display are sometimes simply referred to as display device. The terminal device 900 receives an image from the control unit 700 via the relay unit 750 by wireless communication such as Wi-Fi. The terminal device 900 transmits a signal indicating an operation instruction of a user P1 to the control unit 700 via the relay unit 750. The terminal device 900 is also referred to as “operation unit”.

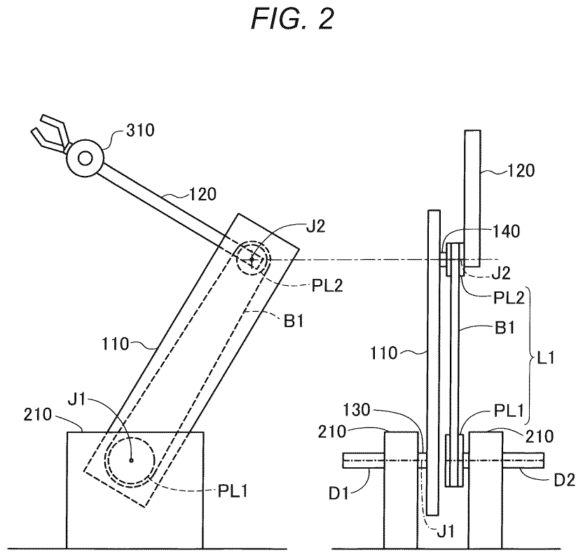

FIG. 2 is a diagram illustrating a mechanism for connecting the first arm 110 and the second arm 120. A side view of the robot 100 is illustrated in a left part of FIG. 2 and a rear view of the robot 100 is illustrated in a right part of FIG. 2. The rear view illustrates a case in which the robot 100 is viewed in an arrow A2 direction in FIG. 1.

The drive mechanism D1 rotationally drives the joint section 130. The drive mechanism D1 includes a stepping motor, a speed reducer, and a driver not illustrated in the figure. The stepping motor provided in the drive mechanism D1 is also referred to as “first motor”. Hereinafter, the stepping motor is sometimes simply referred to as motor. The stepping motor provided in the drive mechanism D1 is driven, whereby the rotation shaft J1 rotates. In the present embodiment, the drive mechanism D1 does not include an encoder. In general, when the stepping motor is driven, a step-out phenomenon sometimes occurs in which rotation cannot follow a given pulse rate and an error occurs between an assumed axis angle and an actual axis angle. An encoder that measures the actual axis angle is required in order to correct the error. In the present embodiment, the position of an arm is detected by the mark 310 and the arm is controlled based on the detected position. For this reason, even if an error occurs between the assumed axis angle and the actual axis angle, the error is corrected in the next control cycle. For this reason, there is no problem even if the encoder is not provided. The same applies to the drive mechanism D2 explained below.

The drive mechanism D2 rotationally drives the joint section 140. The drive mechanism D2 includes a stepping motor, a speed reducer, and a driver not illustrated in the figure. The stepping motor provided in the drive mechanism D2 is also referred to as “second motor”. A rotational force generated by driving the stepping motor provided in the drive mechanism D2 is transmitted to the joint section 140 via the link mechanism L1. The link mechanism L1 includes a driving pulley PL1, a driven pulley PL2, and a belt B1. The drive pulley PL1 is attached to a rotation shaft of the stepping motor provided in the drive mechanism D2. The driven pulley PL2 is attached to the joint section 140. The driven pulley PL2 is rotatable around the rotation shaft J2. The belt B1 is wound on the driving pulley PL1 and the driven pulley PL2. A gear ratio obtained by dividing the number of teeth of the driving pulley PL1 by the number of teeth of the driven pulley PL2 is desirably a value of 1 or more. Accordingly, when the arm is viewed from a side when moving forward, the distal end of the arm draws an inverted arch-shaped trajectory. As a result, the movement of the arm can be caused to act in a direction for cancelling collision of the arm with a shelf or the like.

The driving pulley PL1 rotates according to the driving of the stepping motor provided in the drive mechanism D2. The rotation of the driving pulley PL1 is transmitted to the driven pulley PL2 via the belt B1. When the driven pulley PL2 rotates, the rotation shaft J2 rotates. As a result, the second arm 120 rotates with respect to the first arm 110. Accordingly, an amount of change in the posture of the second arm 120 caused by the rotation of the first arm 110 decreases. More specifically, the link mechanism L1 is a mechanism that mechanically transmits at least part of power output by the stepping motor, which drives the rotation shaft J1, to the second arm 120 to thereby act in a direction in which the rotation of the second arm 120 caused by the rotation of the first arm 110 is canceled.

The link mechanism L1 may be configured to move the second arm 120 in parallel in association with the rotation of the first arm 110. The link mechanism L1 configured as explained above is referred to as parallel link mechanism. The moving the second arm 120 in parallel means moving the second arm 120 while keeping the posture of the second arm 120. In this case, an angle of the second arm 120 with respect to the ground can be always fixed. Compared to an aspect in which the link mechanism L1 is not adopted, it is possible to prevent the control point from drawing a large trajectory. Alternatively, the link mechanism L1 may be configured to move the second arm 120 in non-parallel in association with the rotation of the first arm 110. The link mechanism L1 configured as explained above is referred to as non-parallel link mechanism. The moving the second arm 120 in non-parallel means moving the second arm 120 without keeping the posture of the second arm 120. In this case, the effect of cancelling the amount of change in the Y coordinate of the control point by the first arm 110 is greater than with the parallel link mechanism.

For example, it is assumed that only the rotation shaft J1 is rotated in an aspect in which the link mechanism L1 is not provided. In this case, the posture of the second arm 120 greatly changes in association with the rotation of the first arm 110. In order to prevent the posture of the second arm 120 from greatly changing in association with the rotation of the first arm 110, it is also conceivable to simultaneously rotate the rotation shaft J1 and the rotation shaft J2 or to sequentially rotate the rotation shaft J1 and the rotation shaft J2 at an extremely short time interval. In this case, it is necessary to calculate a rotation amount of the rotation shaft J2 for offsetting a displacement amount of the posture of the second arm 120 due to the rotation of the rotation shaft J1.

The link mechanism L1 acts in a direction for cancelling the rotation of the second arm 120 caused by the rotation of the first arm 110. Since the link mechanism L1 is provided, the amount of change in the posture of the second arm 120 associated with the rotation of the first arm 110 can be reduced. For this reason, it is unnecessary to calculate the rotation amount of the rotation shaft J2 for offsetting the displacement amount of the posture of the second arm 120 due to the rotation of the rotation shaft J1.

Robots according to a second and subsequent embodiments include the drive mechanism D1 that rotates the joint section 130, the drive mechanism D2 that rotates the joint section 140, and the link mechanism L1.

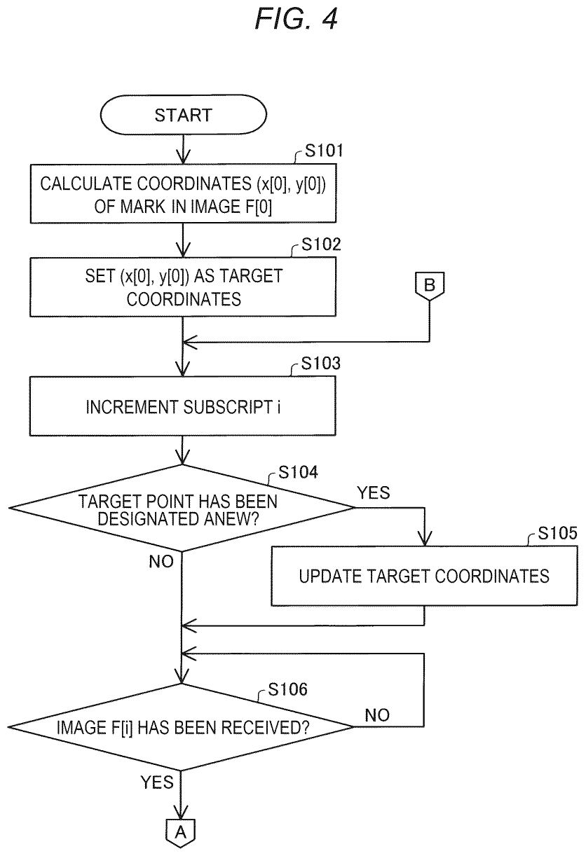

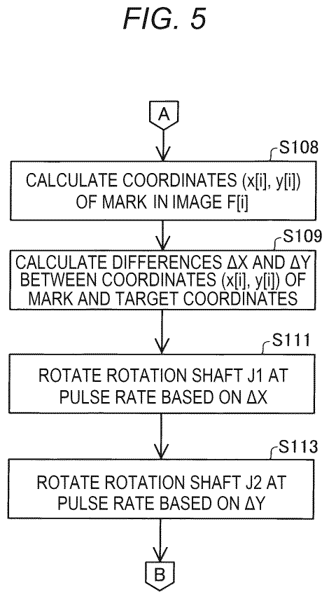

FIGS. 4 and 5 are flowcharts illustrating processing relating to generation of a trajectory of an arm. This processing is started, for example, when an image is received from the camera 510. For example, when being started by operation of the user P1, the camera 510 executes imaging in each fixed period and outputs a captured image to the control unit 700. The initial value of the subscript i of the image F[i] acquired by the camera 510 is 0.

As illustrated in FIG. 4, in step S101, the control unit 700 calculates coordinates (x[0], y[0]) representing the position of the mark 310 from an image F[0] supplied from the camera 510. The control unit 700 calculates coordinates of the mark 310 in the image F[i] based on a luminance value of the image F[i]. Since the mark 310 includes the light emitting section LD, the coordinates of the mark 310 in the image F[i] can be specified based on the luminance value of the image F[i]. As illustrated in FIG. 3, the calculated coordinates of the mark 310 are set as (x[i], y[i]). When the image F[i] is not a grayscale image but an RGB image, the luminance value can be calculated based on RGB values.

In the present embodiment, the control point of the robot 100 is caused to reach an apple, which is a target TG, and thereafter the robot 100 is caused to grip the apple, which is the target TG. Although an example of an image in which the entire robot 100 is reflected is illustrated in FIG. 3, the entire robot 100 may not be reflected in the image captured by the camera 510. It is sufficient that at least the mark 310 and the target TG are reflected in the image captured by the camera 510.

As illustrated in FIG. 4, in step S102, the control unit 700 sets the coordinates (x[0], y[0]) as target coordinates (Xg, Yg). As illustrated in FIG. 3, the target coordinates (Xg, Yg) represent a target point that the control point should reach. By setting initial values of the target coordinates as current coordinates of the mark 310, it is possible to prevent the robot 100 from making an unexpected motion.

As illustrated in FIG. 4, the subscript i is incremented in step S103.

In step S104, the control unit 700 discriminates whether a target point has been designated anew. For example, every time the control unit 700 receives the image F[i] from the camera 510, the control unit 700 transmits the image F[i] to the terminal device 900. The terminal device 900 displays the received image F[i] on the display device. The user P1 can designate a new target point by performing pointing operation on any position on the image F[i] displayed on the terminal device 900. The terminal device 900 transmits information indicating the target point designated by the user P1 to the control unit 700 via the relay unit 750.

When a target point has been designated anew (step S104; YES), processing in step S105 is executed. When a target point has not been designated anew (step S104; NO), processing in step S106 is executed.

In step S105, the control unit 700 calculates coordinates representing the designated target point in the image F[i] using the position where the pointing operation is performed on the display device and the image F[i]. The control unit 700 updates the target coordinates (Xg, Yg) with the calculated coordinates.

In step S106, the control unit 700 discriminates whether the image F[i] has been received from the camera 510. When the image F[i] has been received from the camera 510 (step S106; YES), processing in step S108 (see FIG. 5) is executed.

As illustrated in FIG. 5, in step S108, the control unit 700 calculates the coordinates (x[i], y[i]) of the mark 310 in the image F[i] based on the luminance value of the image F[i].

In step S109, the control unit 700 calculates differences ΔX and ΔY representing the differences between the target coordinates (Xg, Yg) in the image F[i] and the coordinates (x[i], y[i]) representing the current position of the mark 310. As illustrated in FIG. 3, the difference between an X coordinate of the mark 310 and an X coordinate of the target point on the X axis is ΔX and the difference between a Y coordinate of the mark 310 and a Y coordinate of the target point on the Y axis is ΔY. ΔX is equal to Xg−x[i]. ΔY is equal to Yg−y[i]. When ΔX and ΔY are real numbers, for example, values of ΔX and ΔY are rounded off to the nearest integers.

In step S111, the control unit 700 rotates the rotation shaft J1 at a pulse rate based on ΔX. First, the control unit 700 determines a rotation direction of the rotation shaft J1. When ΔX is a positive value, the rotation direction of the rotation shaft J1 is counterclockwise. When ΔX is a negative value, the rotation direction of the rotation shaft J1 is clockwise. The rotation direction of the rotation shaft J1 determined according to whether ΔX is positive or negative is not limited to the example explained above. The rotation direction of the rotation shaft J1 is set as appropriate based on an attachment position of the base 210, a positional relationship between the robot 100 and the target TG, and the like. Further, the control unit 700 determines, referring to a rotation amount table TBx on the X axis, a displacement amount per unit time of the rotation of a motor of the drive mechanism D1 that rotates the joint section 130.

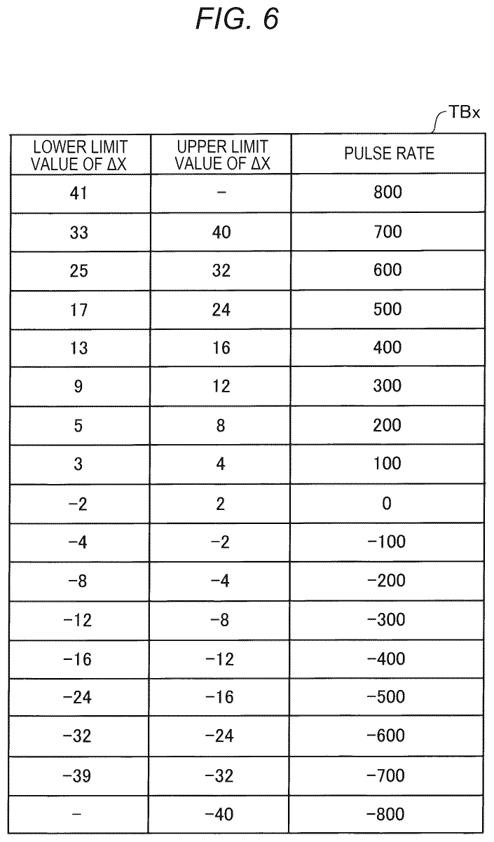

FIG. 6 is a diagram illustrating an example of the rotation amount table TBx. The rotation amount table TBx defines, according to ΔX, a pulse rate representing a displacement amount of rotation of the motor that rotates the joint section 130. In general, the speed of a stepping motor is represented by the number of pulses per second (the number of steps). The number of pulses per second (the number of steps) is referred to as pulse rate. The pulse rate is also referred to as pulse frequency. In the rotation amount table TBx, the pulse rate corresponding to ΔX is defined such that the pulse rate increases as ΔX increases and the pulse rate decreases as ΔX decreases. Thus, control for increasing the rotation of the first arm 110 when the robot 100 is present at a position far from the target point and reducing the rotation of the first arm 110 when the robot 100 is present at a position close to the target point is performed. By causing the robot 100 to operate more finely as the robot 100 is closer to the target point, the control point of the robot 100 is prevented from passing through the target point.

In the rotation amount table TBx, ΔX is in a predetermined range near 0 and the pulse rate is set to 0. In the example illustrated in FIG. 6, when ΔX is in a range of −2 to 2, the pulse rate is set to 0. Accordingly, ΔX converges in the predetermined range near 0 and the rotation shaft J1 finally stops.

In the rotation amount table TBx, the pulse rate taking a negative value indicates that the stepping motor that drives the joint section 130 should rotate in a direction opposite to the determined rotation direction. For example, when a hand position of the robot 100 overreaches the target point, the hand position of the robot 100 needs to be brought close to the target point by reversely rotating the stepping motor of the drive mechanism D1. As illustrated in FIG. 3, the rotation amount table TBx is set as appropriate according to the attachment position of the base 210, the positional relationship between the robot 100 and the target TG, and the like.

The control unit 700 drives the stepping motor of the drive mechanism D1 by controlling the driver of the drive mechanism D1 in the determined rotation direction and at the determined pulse rate. Thus, the first arm 110 rotates around the rotation shaft J1.

In step S113, the control unit 700 rotates the rotation shaft J2 at a pulse rate based on ΔY. First, the control unit 700 determines a rotation direction of the rotation shaft J2. When ΔY is a positive value, the rotation direction of the rotation shaft J2 is counterclockwise. When ΔY is a negative value, the rotation direction of the rotation shaft J2 is clockwise. Since ΔY being 0 corresponds to the absolute value of ΔY being equal to or smaller than a threshold Ymin, the processing in step S113 is not executed. The rotation direction of the rotation shaft J2 determined according to whether ΔY is positive or negative is not limited to the above example. Further, the control unit 700 determines a displacement amount of the rotation of the motor corresponding to ΔY referring to a rotation amount table TBy on the Y axis. Although illustration of the rotation amount table TBy is omitted, the rotation amount table TBy defines, according to ΔY, a pulse rate representing a displacement amount of rotation of a motor that rotates the joint section 140. As in the rotation amount table TBx, in the rotation amount table TBy, a pulse rate corresponding to ΔY is defined such that the pulse rate increases as ΔY increases and the pulse rate decreases as ΔY decreases. Thus, control for increasing the rotation amount of the second arm 120 when the robot 100 is present at a position far from the target point and reducing the rotation amount of the second arm 120 when the robot 100 is present at a position close to the target point is performed. By causing the robot 100 to operate more finely as the robot 100 is closer to the target point, the control point of the robot 100 is prevented from passing through the target point.

As in the rotation amount table TBx, in the rotation amount table TBy, ΔY is in a predetermined range near 0 and the pulse rate is set to 0. Accordingly, ΔY converges in a predetermined range near 0 and the rotation shaft J2 finally stops.

The control unit 700 drives the stepping motor of the drive mechanism D2 by controlling the driver of the drive mechanism D2 in the determined rotation direction and at the determined pulse rate. Thus, the second arm 120 rotates around the rotation shaft J2.

According to the present embodiment, the displacement amount of the rotation amount of the motor is determined based on the differences between the coordinate values of the mark 310 and the designated target coordinates in the captured image F[i]. According to this aspect, it is unnecessary to execute processing with a large load such as coordinate conversion in order to cause a robot to operate as in the related art. Thus, a processing load of robot control can be reduced. Since the rotation around the rotation shaft J1 (see step S111 in FIG. 5) and the rotation around the rotation shaft J2 (see step S113 in FIG. 5) are independently controlled, the control of the robot 100 by the control unit 700 is not complicated.

In the present embodiment, the robot 100 is caused to operate such that the distance between the mark 310 and the designated target point gradually decreases in the captured image F[i]. By using the visual servoing, the processing of converting a three-dimensional position of a target in a stereo camera coordinate system into a three-dimensional position in a robot coordinate system as in the related art becomes unnecessary and a processing load can be reduced. The first arm 110 or the second arm 120 is sometimes bent by, for example, the weight of an object gripped by the robot 100. Even in such a case, a pulse rate of the motor that rotates the joint section 130 or the joint section 140 is only determined based on the differences between the coordinates of the mark 310 and the coordinates of the target point in the captured image F[i]. This is because the coordinates of the mark 310 in the captured image F[i] are coordinates in a state in which the first arm 110 or the second arm 120 is bent. In the visual servoing, information concerning a captured image is feedback information. Therefore, the control of the robot 100 by the control unit 700 can be simplified.

### A2. Modification 1

In the example illustrated in FIG. 3, only the joint section 130 rotates, whereby the end portion of the first arm 110 on the side coupled to the second arm 120 moves mainly in the X-axis direction in images continuously captured in time series. The rotation of the first arm 110 greatly affects movement of the control point of the robot 100 in the X-axis direction. Only the joint section 140 rotates, whereby the end portion of the second arm 120 on the side coupled to the end effector 400 mainly moves in the Y-axis direction in the images continuously captured in time series. The rotation of the second arm 120 greatly affects movement of the control point of the robot 100 in the Y-axis direction. However, these premises are different depending on the attachment position of the base 210, the positional relationship between the robot 100 and the target TG, and the like.

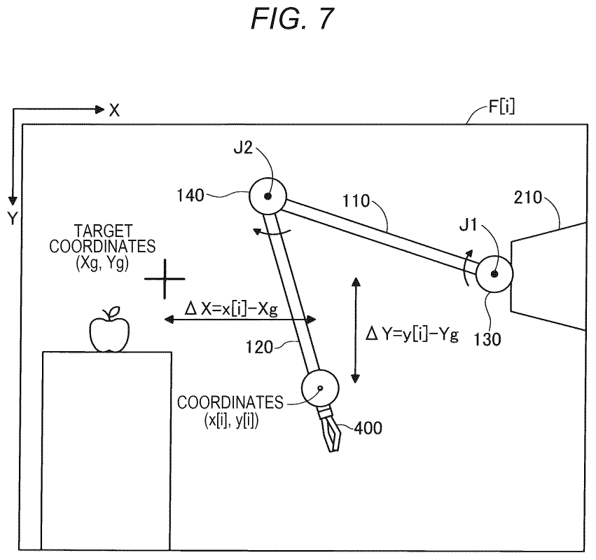

FIG. 7 is a diagram illustrating an example of the image F[i] captured by the camera 510 when the base 210 of the robot 100 is fixed to a wall. In the illustrated example, the first arm 110 extends in the X-axis direction in the image F[i]. Only the joint section 130 rotates, whereby the end portion of the first arm 110 on the side coupled to the second arm 120 mainly moves in the Y-axis direction in images continuously captured in time series. In the illustrated example, the rotation of the first arm 110 greatly affects movement of the control point of the robot 100 in the Y-axis direction. Only the joint section 140 rotates, whereby the end portion of the second arm 120 on the side coupled to the end effector 400 mainly moves in the X-axis direction in the images continuously captured in time series. The rotation of the second arm 120 greatly affects movement of the control point of the robot 100 in the X-axis direction.

For this reason, in the example illustrated in FIG. 7, the control unit 700 determines, referring to a rotation amount table on the Y axis, a displacement amount of rotation of the motor, which rotates the joint section 130, corresponding to ΔY. The control unit 700 determines, referring to a rotation amount table on the X axis, a displacement amount of rotation of the motor that rotates the joint section 140 corresponding to ΔX.

### A3. Modification 2

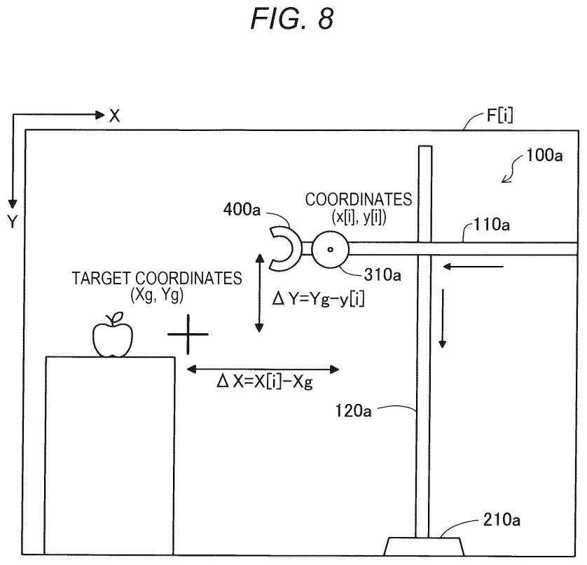

FIG. 8 is a diagram illustrating the image F[i] obtained by imaging a robot 100a having a different arm configuration. The robot 100a illustrated in FIG. 8 is configured as a Cartesian coordinate robot. The Cartesian coordinate robot may be referred to as a gantry robot. The robot 100a includes a first slider 110a, a second slider 120a, a base 210a, a mark 310a, an end effector 400a, and the camera 510. Illustration of the camera 510 is omitted. The position and the posture of the camera 510 are fixed with respect to the base 210a. The camera 510 images the first slider 110a and the second slider 120a at a determined frame rate. The camera 510 only has to be disposed at a position where the camera 510 can image at least the mark 310a and the target point.

One end portion of the second slider 120a is coupled to the base 210a. The second slider 120a extends in the perpendicular direction. The second slider 120a supports the first slider 110a movably in the perpendicular direction. The first slider 110a can linearly move in the horizontal direction in a state of being supported by the second slider 120a. The end effector 400a is attached to the distal end of the first slider 110a. The mark 310a is attached to the first slider 110a in the vicinity of the end effector 400a. The first slider 110a linearly moves in the horizontal direction, whereby a control point of the robot 100a linearly moves in the X-axis direction in images continuously captured in time series. The second slider 120a linearly moves the first slider 110a in the perpendicular direction, whereby the control point of the robot 100a linearly moves in the Y-axis direction in the images continuously captured in time series.

Here, in an image captured by the camera 510, a virtual plane parallel to the X axis and the Y axis is assumed. The control point is movable in a virtual plane. The control unit 700 calculates coordinates of the mark 310a in the image captured by the camera 510 and controls a movement amount in the X-axis direction and a movement amount in the Y-axis direction of the first slider 110a using the differences between current coordinates of the mark 310a and target coordinates of the target point.

### B. SECOND EMBODIMENT

### B1. Basic Configuration

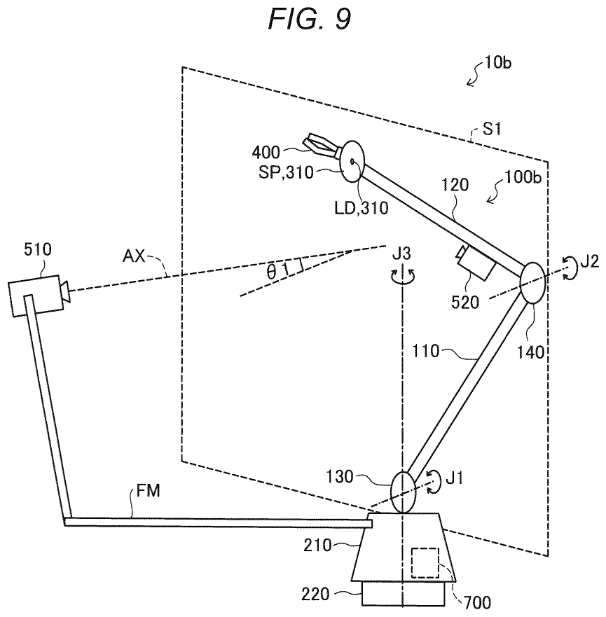

FIG. 9 is a diagram illustrating a schematic configuration of a robot system 10b according to a second embodiment. In the following explanation, components different from the components in the first embodiment are mainly explained and explanation is omitted about the same components as the components in the first embodiment. As explained above, in the first embodiment, the movable range of the control point of the robot 100 is within the imaginary plane S1 and the movable range of the control point of the robot 100 is limited to the two-dimensional space. In the present embodiment, the movable range of the control point of the robot 100 is expanded to a three-dimensional space.

The robot system 10b includes a robot 100b, the control unit 700, and the terminal device 900. In FIG. 9, illustration of the terminal device 900 is omitted. The robot 100b includes the first arm 110, the second arm 120, the joint section 130, the joint section 140, the base 210 that supports the first arm 110 and the second arm 120, a rotation mechanism 220, the mark 310, the end effector 400, the camera 510, and a camera 520.

As a characteristic configuration in the present embodiment, the robot 100b includes the rotation mechanism 220. The base 210 is disposed on the rotation mechanism 220. The first arm 110 and the second arm 120 are disposed on the rotation mechanism 220 together with the base 210. The rotation mechanism 220 rotates the base 210 around a rotation shaft J3 according to control of the control unit 700. The rotation shaft J3 is also referred to as “third rotation shaft”. The rotation shaft J3 is parallel to the vertical direction. Here, “parallel” includes not only a state in which the rotation shaft J3 is strictly parallel to the vertical direction but also a state in which the rotation shaft J3 is substantially parallel to the vertical direction. The rotation shaft J3 is perpendicular to the rotation shaft J1. Here, “perpendicular” includes not only a state in which the rotation shaft J3 is strictly perpendicular to the rotation shaft J1 but also a state in which the rotation shaft J3 is substantially perpendicular to the rotation shaft J1. The rotation shaft J3 being substantially perpendicular to the rotation shaft J1 means that an angle of the rotation shaft J3 with respect to the rotation shaft J1 is in a range of 80 degrees to 90 degrees.

The rotation mechanism 220 rotates the base 210, whereby a control point of the robot 100b rotates around the rotation shaft J3. In this way, a moving range of the control point of the robot 100b is expanded to a three-dimensional space. The control unit 700 does not rotate the joint sections 130 and 140 while rotating the rotation mechanism 220. The control unit 700 does not cause the rotation mechanism 220 to rotate the base 210 while rotating at least one of the joint section 130 and the joint section 140. Thus, control of an operation of the robot 100b by the control unit 700 is prevented from becoming complicated.

A configuration and a function of the camera 510 are the same as those in the first embodiment.

The camera 520 is fixed to the second arm 120 at a position where and in a posture in which the camera 520 is capable of performing imaging in a moving direction of the second arm 120. The camera 520 performs, at a constant frame rate, imaging in a direction in which the second arm 120 extends. The direction in which the second arm 120 extends is also referred to as “moving direction of the second arm”. As the camera 520, for example, a board camera can be used. The camera 520 directly outputs a captured image to the control unit 700. The camera 520 may be fixed to the first arm 110. The camera 520 is also referred to as a “second camera”.

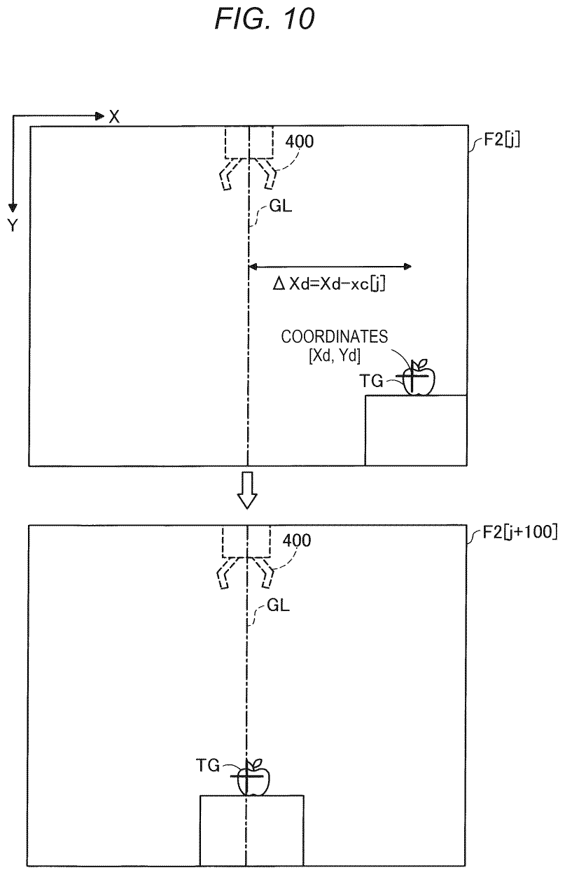

FIG. 10 is a diagram illustrating an example of an image F2[j] captured by the camera 520. An image supplied from the camera 520 is referred to as image F2[j]. A subscript j is a positive integer that is added up every time imaging is executed. Coordinates of a pixel at the upper left corner of the image F2[j] are set as a coordinate origin of the image F2[j]. The right direction of the image F2[j] is set as a positive direction of the X axis and the downward direction of the image F2[j] is set as a positive direction of the Y axis.

The control unit 700 transmits the image F2[j] received from the camera 520 to the terminal device 900 every time an image is received from the camera 520. The terminal device 900 displays the received image F2[j] on a display device. The frame rate at which the camera 520 executes the imaging is set to be high to some extent. Images F2[j] continuously displayed on the display device of the terminal device 900 constitute a moving image. While viewing an image F2 displayed on the terminal device 900, a user operates rotation of the rotation mechanism 220 such that the moving direction of the second arm 120, that is, the control point faces the target TG. For example, the user performs pointing operation on a virtual button or the like displayed on the display device of the terminal device 900 to issue an operation instruction to rotate the rotation shaft J3 clockwise or counterclockwise. The terminal device 900 transmits a signal corresponding to the operation instruction to the control unit 700. The control unit 700 controls the rotation of the rotation mechanism 220 in response to the signal received from the terminal device 900. Alternatively, the user can issue an instruction concerning rotation by operating a mouse or performing swipe operation on a touch panel display.

Since the camera 520 is fixed to the second arm 120, an X coordinate of the distal end portion of the second arm 120 on the image F2 substantially coincides with an X coordinate of the control point regardless of an angle of the arm and an angle of the rotation mechanism 220. Therefore, a guide line GL matched with the X coordinate of the distal end portion of the second arm 120 on the image F2 is desirably superimposed and displayed on the image F2. The guide line GL indicates the center position of the end effector 400. In FIG. 10, in order to represent the position of the end effector 400, the end effector 400 represented by a broken line is superimposed on the image F2. The user performs pointing operation on any position on the image F2[j] displayed on the display device to thereby designate a direction in which the distal end portion of the second arm 120 is directed. In an upper part of FIG. 10, a cross displayed to be superimposed on the target TG represents a position where the pointing operation is performed by the user. The user only has to issue an operation instruction for the rotation of the rotation mechanism 220 with the aim of superimposing the target TG and the guide line GL. Thus, operation becomes easier for the user.

Based on a position touched on the image F2[j], the control unit 700 controls the rotation mechanism 220 to direct the distal end portion of the second arm 120 to the designated direction. In order to facilitate understanding of the technique, it is assumed that an X coordinate of the distal end of the second arm 120 and an X coordinate of the control point of the robot 100b coincide with each other in the image F2[j]. A known algorithm may be adopted in order to control the rotation of the rotation mechanism 220.

For example, the control unit 700 may control the rotation mechanism 220 based on the position touched on the image F2[j] using an object tracking algorithm. As the object tracking algorithm, there are ORB-SLAM (Raul Mur-Artal, other two persons, “ORB-SLAM: A Versatile and Accurate Monocular SLAM System”, IEEE Transactions on Robotics, vol. 31, no. 5, pp. 1147-1163, October 2015, [online], [searched on Jan. 10, 2025], Internet URL: https://doi.org/10.1109/TRO.2015.2463671), which is a feature point-based method, and DTAM (Richard A. Newcombe, other two persons, “DTAM: Dense Tracking and Mapping in Real-Time”, IEEE Xplore, [online], [searched on Jan. 10, 2025], Internet URL: https://doi.org/10.1109/ICCV.2011.6126513), which is a direct method, and the like. In the present embodiment, the user only has to perform pointing operation on any position on the image F2[j] displayed on the display device to indicate a target point. The control unit 700 can direct the moving direction of the second arm 120 to the direction of the indicated target point on a real space using the object tracking algorithm according to the operation instruction of the user. The user can rotate the rotation mechanism 220 with a more intuitive and simple operation instruction.

Since the rotation shaft J1 and the rotation shaft J2 are parallel to each other, an operation of a robot system is limited to the inside of a two-dimensional plane in an aspect in which the rotation mechanism 220 is not provided. In the present embodiment, the base 210 can be rotated around the rotation shaft J3 perpendicular to the rotation shaft J1. Thus, moving ranges of the first arm 110 and the second arm 120 can be expanded to a three-dimensional space.

### B2. Modification

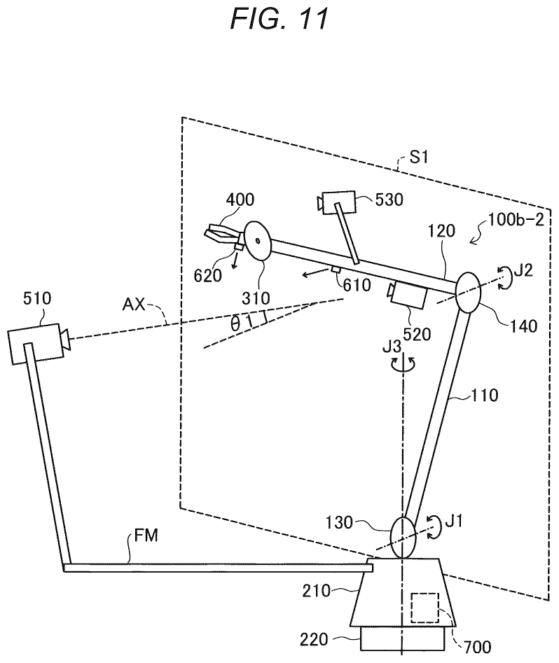

FIG. 11 is a diagram illustrating a schematic configuration of a robot 100b-2 according to a modification in the second embodiment. Hereinafter, components different from the basic configuration in the second embodiment explained above are mainly explained. The robot 100b-2 includes a camera 530, a first guide light irradiation unit 610, and a second guide light irradiation unit 620 in addition to the first arm 110, the second arm 120, the joint section 130, the joint section 140, the base 210 that supports the first arm 110 and the second arm 120, the rotation mechanism 220, the mark 310, the end effector 400, the camera 510, and the camera 520. The robot 100b-2 may not include the rotation mechanism 220.

In the modification in the second embodiment, for example, the robot 100b-2 is caused to perform an operation of placing, on a placement table T1, the target TG gripped by the end effector 400.

The camera 530 is fixed to the second arm 120 at a position where and in a posture in which the camera 530 is capable of imaging the end effector 400. The camera 530 images the end effector 400 at a constant frame rate. As illustrated in FIG. 11, the camera 530 is disposed at a position closer to the end effector 400 compared with the camera 510 and the camera 520. As the camera 530, for example, a board camera can be used. The camera 530 directly outputs a captured image to the control unit 700. The camera 530 is also referred to as “third camera”.

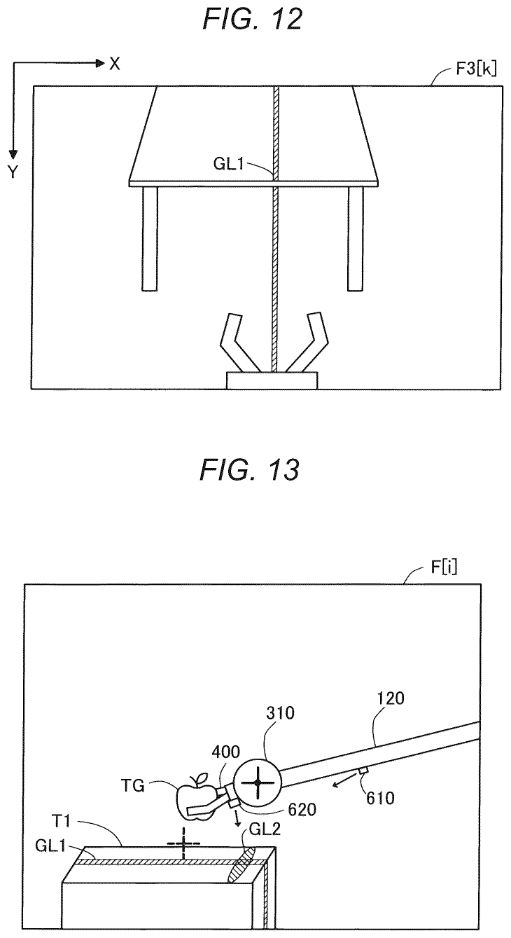

FIG. 12 is a diagram illustrating an example of the image captured by the camera 530. In FIG. 12, illustration of the target TG gripped by the end effector 400 is omitted. The image captured by the camera 530 is referred to as image F3[k]. A subscript k is a positive integer that is added up every time imaging is executed. The control unit 700 displays the image F3[k] captured by the camera 530 on a not-illustrated display device. The user can check the end effector 400 in the image F3[k] displayed on the display device. Since the camera 510 is disposed at a position where the camera 510 can image the mark 310, the camera 510 is located at a position separated from the robot 100b-2 to some extent. For this reason, it is sometimes difficult to check a state of the end effector 400 in detail in an image captured by the camera 510. In contrast, since the camera 530 is disposed at a position close to the end effector 400, the user can check the state of the end effector 400 and the moving direction of the second arm 120 in detail with the image captured by the camera 530.

As illustrated in FIG. 11, the first guide light irradiation unit 610 is fixed to the second arm 120. As the first guide light irradiation unit 610, for example, a line laser that projects linear laser light can be adopted. As illustrated in FIG. 12, the first guide light irradiation unit 610 irradiates linear guide light GL1 in the moving direction of the second arm 120. Here, when the second arm 120 is viewed from a side surface, the guide light GL1 is disposed to be present on the imaginary plane S1. More specifically, when the second arm 120 is viewed from the side surface, the guide light GL1 spreads to some extent in a direction intersecting a traveling direction of light on the imaginary plane S1. At least a part of the imaginary plane S1 can be visually recognized by the guide light GL1. The first guide light irradiation unit 610 is also referred to as “first irradiation unit”.

As illustrated in FIG. 11, the second guide light irradiation unit 620 is fixed near the end portion of the second arm 120 to which the end effector 400 is connected. As the second guide light irradiation unit 620, for example, a point light source LED can be adopted. The second guide light irradiation unit 620 irradiates, with light, a place having a predetermined positional relationship with the end effector 400. In an illustrated example, the second guide light irradiation unit 620 irradiates a place immediately below the end effector 400 with light. The second guide light irradiation unit 620 is also referred to as “second irradiation unit”.

FIG. 13 is a diagram illustrating an example of the image F[i] captured by the camera 510 in a state in which the first guide light irradiation unit 610 is emitting guide light and the second guide light irradiation unit 620 is emitting light. As illustrated in FIG. 13, the guide light GL1 emitted from the first guide light irradiation unit 610 and the guide light GL2 emitted from the second guide light irradiation unit 620 are projected onto the placement table T1. When the end effector 400 has not reached above the placement table T1, the light emitted from the second guide light irradiation unit 620 is projected onto a floor rather than the placement table T1.

The user can check, with the image F[i] captured by the camera 510, a target onto which the guide light GL1 is projected. With the guide light GL1, the user can visually recognize a reachable range of an operating point of the end effector 400. For example, a gripper, which is the end effector 400, is gripping an object and the robot 100b-2 is sometimes caused to operate to perform work of placing the gripped object on the placement table T1. In this case, the user can designate, with the image F[i], using light emitted from the first guide light irradiation unit 610 to the placement table T1 as a guide, a position where the object is placed. The user can easily discriminate, according to whether the light emitted from the second guide light irradiation unit 620 has reached above the placement table T1, whether the end effector 400 has reached above the placement table T1.

As illustrated in FIG. 13, when the end effector 400 reaches above the placement table T1, for example, the user may designate final target coordinates by performing pointing operation on any position of the image F[i] displayed on the not-illustrated display device. In an illustrated example, a target point designated at the present time point is represented by a solid-line cross and a final target point designated anew is represented by a broken-line cross. In the illustrated example, a target point is designated considering an offset between the mark 310 and the target TG.

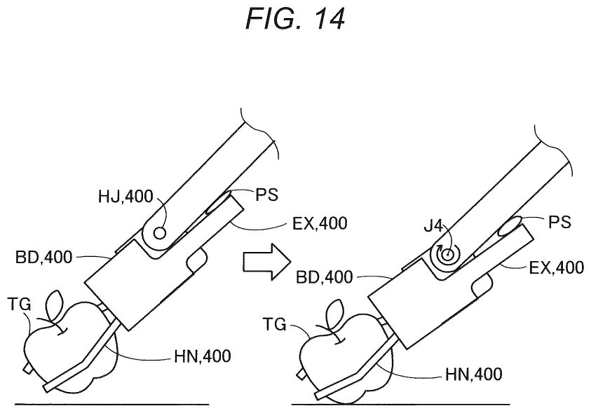

FIG. 14 is a diagram concerning a sensor provided at the distal end portion of the second arm 120. In FIG. 14, the end effector 400 and the distal end portion of the second arm 120 in a state of gripping an apple serving as the target TG are illustrated. In a left part of FIG. 14, a state in which the target TG gripped by the end effector 400 is not in contact with the placement table T1 is illustrated. In a right part of FIG. 14, a state in which the target TG gripped by the end effector 400 is in contact with another object on the placement table T1 is illustrated.

The end effector 400 includes a hand section HN that grips the target TG, a main body section BD to which the hand section HN is attached, a hinge joint HJ, and an extension section EX. The extension section EX extends from the main body section BD in a direction in which the second arm 120 extends. The extension section EX is disposed to face the surface on the lower side of the distal end portion of the second arm 120. The robot 100b-2 further includes a pressure sensor PS. The end effector 400 is coupled to the distal end portion of the second arm 120 by the hinge joint HJ. The hinge joint HJ rotates, whereby the hand section HN, the main body section BD, and the extension section EX rotate around a rotation shaft J4. The rotation shaft J4 is parallel to the rotation shaft J1. The pressure sensor PS is disposed between the extension section EX and the surface on the lower side of the distal end portion of the second arm 120. The pressure sensor PS is connected to the control unit 700 by a not-illustrated signal line. A detection value of the pressure sensor PS is transmitted to the control unit 700.

As illustrated in a left part of FIG. 14, in a state in which the target TG gripped by the end effector 400 is not in contact with the placement table T1, the extension section EX does not rotate around the rotation shaft J4. In a state in which the extension section EX is not rotating around the rotation shaft J4, pressure is applied from the extension section EX to the pressure sensor PS. As illustrated in a right part of FIG. 14, when the target TG gripped by the end effector 400 comes into contact with the placement table T1, the extension section EX rotates around the rotation shaft J4. When the extension section EX rotates around the rotation shaft J4, the extension section EX moves in a direction away from the pressure sensor PS. Thus, the pressure applied from the extension section EX to the pressure sensor PS decreases. The control unit 700 discriminates, based on a change in the detection value of the pressure sensor PS, whether the target TG gripped by the end effector 400 has come into contact with the placement table T1. When the control unit 700 discriminates that the target TG gripped by the end effector 400 has come into contact with the placement table T1, the control unit 700 may cause the end effector 400 to execute an operation of releasing the target TG. When, in a state in which the target TG gripped by the end effector 400 is not in contact with the placement table T1, the control unit 700 causes the end effector 400 to perform the operation of releasing the target TG, the target TG falls and an impact is given to the target TG. By using the pressure sensor PS, it is possible to prevent the target TG from falling. It is also possible to prevent the target TG from being pressed against the placement table T1 more than necessary and damaged.

### C. THIRD EMBODIMENT

### C1. Basic Configuration

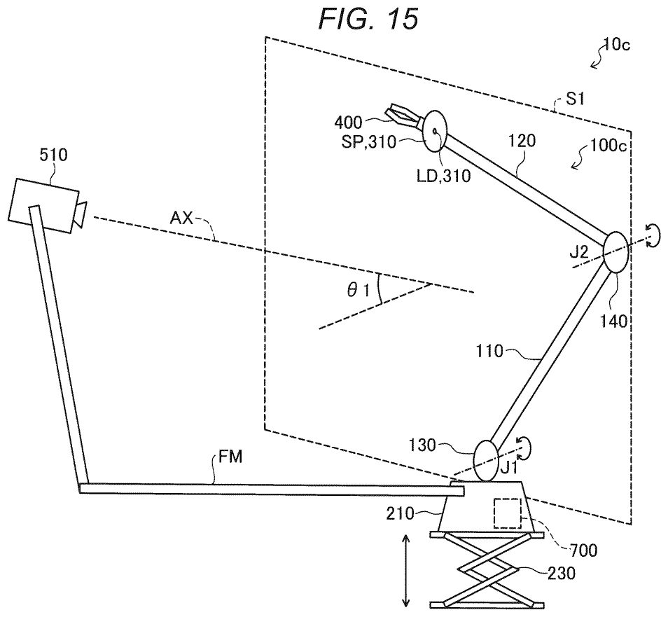

FIG. 15 is a diagram illustrating a schematic configuration of a robot system 10c according to a third embodiment. In the following explanation, components different from the components in the first embodiment are mainly explained and explanation is omitted about the same components as the components in the first embodiment.

The robot system 10c includes a robot 100c, the control unit 700, and the terminal device 900. In FIG. 15, illustration of the terminal device 900 is omitted. The robot 100c includes the first arm 110, the second arm 120, the joint section 130, the joint section 140, the base 210 that supports the first arm 110 and the second arm 120, a lifting and lowering mechanism 230, the mark 310, the end effector 400, and the camera 510.

As a characteristic configuration in the present embodiment, the robot 100c includes the lifting and lowering mechanism 230. The base 210 is disposed on the lifting and lowering mechanism 230. The first arm 110 and the second arm 120 are disposed on the lifting and lowering mechanism 230 together with the base 210. For example, the control unit 700 displays, on a not-illustrated display device, a user interface for receiving an instruction to lift and lower the base 210. When receiving the lifting and lowering instruction via the user interface, the control unit 700 outputs a signal for instructing lifting and lowering to the lifting and lowering mechanism 230. In response to this, the lifting and lowering mechanism 230 lifts and lowers the base 210.

The first arm 110 and the second arm 120 can be moved in the up-down direction by the lifting and lowering mechanism 230. It is possible to expand a reaching range in the up-down direction of a control point without changing the lengths of the arms. The camera 510 is fixed to the base 210 and rises and falls together with the base 210. Even if the base 210 rises and falls, the position and the posture of the camera 510 with respect to the imaginary plane S1 are maintained. Thus, as in the first embodiment, the control unit 700 can control an operation of the robot 100c using so-called visual servoing based on information concerning an image acquired by the camera 510.

### C2. Modification

The robot 100c may include the rotation mechanism 220 and the camera 520 explained in the second embodiment. In this case, the rotation mechanism 220 and the base 210 may be disposed on the lifting and lowering mechanism 230 or the lifting and lowering mechanism 230 may be disposed on the rotation mechanism 220 and the base 210 may be disposed on the lifting and lowering mechanism 230. With the configuration explained above, by expanding the moving ranges of the first arm 110 and the second arm 120 to a three-dimensional space and then moving the first arm 110 and the second arm 120 in the up-down direction, it is possible to enlarge a movable range of the control point in the up-down direction without changing the lengths of the arms.

Further, the robot 100c may include the first guide light irradiation unit 610, the second guide light irradiation unit 620, and the camera 530 explained in the second embodiment.

### D. FOURTH EMBODIMENT

### D1. Basic Configuration

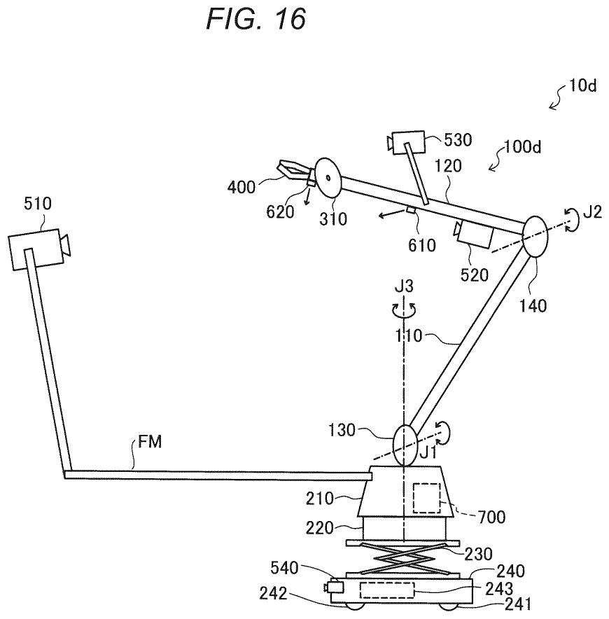

FIG. 16 is a diagram illustrating a schematic configuration of a robot system 10d according to a fourth embodiment. In the following explanation, components different from the components in the first embodiment are mainly explained and explanation is omitted about the same components as the components in the first embodiment.

The robot system 10d includes a robot 100d, the control unit 700, and the terminal device 900. In FIG. 16, illustration of the terminal device 900 is omitted. The robot 100d includes the first arm 110, the second arm 120, the joint section 130, the joint section 140, the base 210 that supports the first arm 110 and the second arm 120, the rotation mechanism 220, the lifting and lowering mechanism 230, a traveling mechanism 240, the mark 310, the end effector 400, the camera 510, the camera 520, the camera 530, the first guide light irradiation unit 610, and the second guide light irradiation unit 620. The configurations of the rotation mechanism 220, the camera 520, the camera 530, the first guide light irradiation unit 610, and the second guide light irradiation unit 620 are as explained in the second embodiment. The configuration of the lifting and lowering mechanism 230 is as explained in the third embodiment.

As a characteristic configuration in the present embodiment, the robot 100d includes the traveling mechanism 240. The lifting and lowering mechanism 230, the rotation mechanism 220, and the base 210 are disposed in this order on the traveling mechanism 240. The first arm 110 and the second arm 120 are disposed on the traveling mechanism 240 together with the base 210. The traveling mechanism 240 moves the base 210 according to control of the control unit 700. The control unit 700 is also referred to as “traveling control unit”.

The traveling mechanism 240 includes a pair of driving wheels 241, a driven wheel 242, a pair of motors that respectively individually drives the pair of driving wheels 241, and a camera 540. In FIG. 16, illustration of the motors is omitted.

The traveling mechanism 240 can travel straight and turn. The traveling mechanism 240 may have a function of performing so-called spin turn in which the traveling mechanism 240 reverses rotation of one of the pair of motors from rotation of the other to turn on the spot. For example, when making the front of the base 210 and the placement table T1 face each other, the traveling mechanism 240 may perform the spin turn. There is an advantage that the distance between the robot 100d and the target TG is minimized. When the robot 100d is operated, rotation around the rotation shaft J3 by the rotation mechanism 220 may be executed from the viewpoint of improving work efficiency. This is because it is assumed that a waiting time occurs in the execution of the spin turn of the traveling mechanism 240 as compared with the execution of the rotation of the rotation mechanism 220.

The traveling mechanism 240 may have a function of performing so-called pivot turn in which the traveling mechanism 240 stops one of the pair of motors and drives the other to turn around a wheel on the stopped side. The traveling mechanism 240 may have a function of performing so-called gentle turn in which the traveling mechanism 240 differentiates rotation speed of one of the pair of motors from rotation speed of the other to gently turn. A configuration of the traveling mechanism 240 is not limited to the configurations explained above. In a housing of the traveling mechanism 240 or the base 210, a rear marker for identifying the rear of the traveling mechanism 240 may be provided. In the housing of the traveling mechanism 240, a proximity sensor, a tactile sensor, a collision detection sensor, and the like may be provided.

The camera 540 is fixed to the housing of the traveling mechanism 240 at a position where and in a posture in which the camera 540 is capable of performing imaging in a moving direction of the traveling mechanism 240. The camera 540 is also referred to as a “front camera”. The camera 540 performs imaging in the moving direction of the traveling mechanism 240 at a constant frame rate. An attachment position of the camera 540 is optional if the camera 540 can perform imaging in the moving direction of the traveling mechanism 240. The camera 540 transmits, to the control unit 700, an image acquired by performing imaging in the moving direction of the traveling mechanism 240. An image captured by the camera 540 is referred to as image F4[l]. The subscript l is a positive integer that is added up every time imaging is executed. The control unit 700 displays, via the Internet communication network or the like, the image F4[l] on a not-illustrated display device present at a remote user. The user can move the robot 100d to a desired place by performing so-called steering of determining a situation while viewing the image F4[l] displayed on the display device and performing operation such as moving the traveling mechanism 240 forward and backward and turning the traveling mechanism 240. As a steering method for the traveling mechanism 240 by the user, a virtual button displayed on the display device, a mouse gesture, a swipe or a gesture on a touch panel, a mouse wheel, or the like is suitable. Alternatively, an object tracking algorithm may be mounted on the control unit 700 to automatically control the traveling mechanism 240 based on the image F4[l].

As the object tracking algorithm, there are ORB-SLAM, which is a feature point-based method, DTAM, which is a direct method, and the like. Although the image F4[l] of the camera 540 smoothly changes as the traveling mechanism 240 moves, the positions of various objects reflected in the image F4[l] can be continuously acquired by using the object tracking algorithm. By using the object tracking algorithm, it is possible to autonomously control the camera 540, that is, the traveling mechanism 240 to face desired any place and approach to a preset distance. Then, simply by the user performing pointing operation on any position on a display screen to indicate a target point for movement, the robot system 10d semi-automatically moves to the indicated target point on a real space. This is more intuitive and convenient work for the user.

### D2. Modification

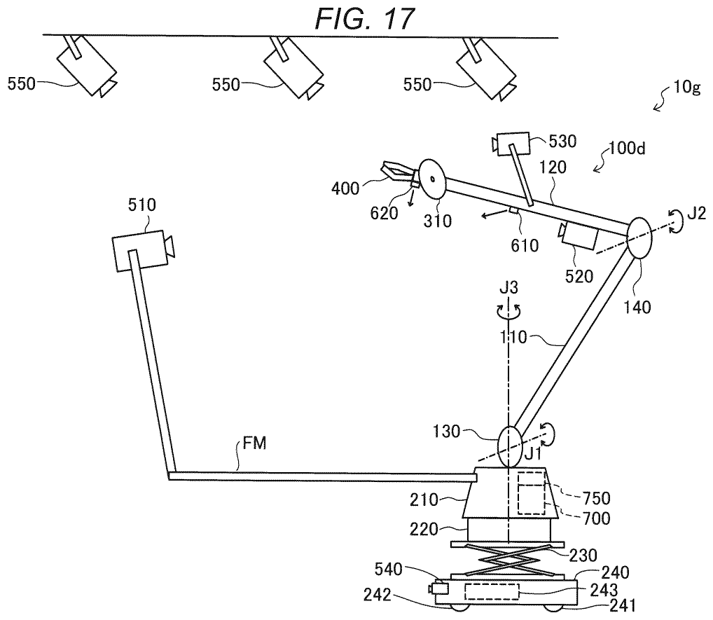

FIG. 17 is a diagram illustrating a schematic configuration of a robot system 10g according to a modification of the fourth embodiment. Hereinafter, components different from the basic configuration in the fourth embodiment explained above are mainly explained and explanation is omitted about the same components as the basic configuration.

The robot system 10g includes the relay unit 750 and a plurality of cameras 550 in addition to the components explained in the basic configuration explained above. The relay unit 750 has the configuration explained in the first embodiment.

The plurality of cameras 550 image the robot 100d from the outside. The camera 550 is also referred to as “external camera”. The plurality of cameras 550 are disposed at positions where the cameras 550 can perform imaging within a range in which the robot 100d is assumed to travel. For example, when the robot 100d travels in a warehouse, the plurality of cameras 550 are fixed to a ceiling or a wall of the warehouse. The cameras 550 continuously performs imaging and transmit captured images to the control unit 700 by wireless communication. The camera 550 and the control unit 700 may directly perform wireless communication or may perform wireless communication via the relay unit 750. An image captured by the camera 550 is referred to as image F5[n]. A subscript n is a positive integer that is added up every time imaging is executed.

The control unit 700 causes the display device of the terminal device 900 to display the images F5[n] received from the plurality of cameras 550. The user can detect an obstacle around the robot 100d and recognize a situation around the robot 100d. It is sometimes difficult to sufficiently recognize the obstacle and the situation around the robot 100d only with the image F4[l] acquired by the camera 540 provided in the traveling mechanism 240. Even in this case, the user can perform highly accurate monitoring for traveling of the robot 100d using the plurality of cameras 550. The user can move the robot 100d to a desired place by determining the situation while viewing the images F5[n] displayed on the display device of the terminal device 900 and performing operation of, for example, moving the traveling mechanism 240 forward and backward and turning the traveling mechanism 240.

Alternatively, a position marker for identifying the position of the traveling mechanism 240 may be provided in the image captured by the camera 550. The position marker includes, for example, a point light source LED. Position markers are preferably provided respectively in the front and the rear of the traveling mechanism 240. In the image F5[n] captured by the camera 550, the user can easily specify the front of the traveling mechanism 240. The control unit 700 may have a function of detecting the position marker based on the image F5[n]. When the user designates a target point, the control unit 700 controls, using the object tracking algorithm, the traveling mechanism 240 to move to the designated target point. In this case, the user does not need to sequentially issue instructions relating to traveling. The user can move the robot 100d to a desired place only by designating a desired position on an image as a target point with pointing operation. Every time the camera 550 acquires an image F5, the control unit 700 controls the traveling of the traveling mechanism 240 using the visual servoing to reduce the differences between coordinates indicating a position marker in the image F5 and coordinates indicating the designated target point. When the coordinates indicating the position marker and the coordinates indicating the target point coincide in the image F5, the robot 100d reaches the target point.

The control unit 700 may estimate, with, for example, Structure from Motion (SfM), a three-dimensional shape around the robot 100d based on the image F4[l] acquired by the camera 540 and the images F5[n] acquired by the cameras 550. Accordingly, it possible to cause the traveling mechanism 240 to travel while avoiding obstacles around the robot 100d.

### E. FIFTH EMBODIMENT

### E1. Basic Configuration

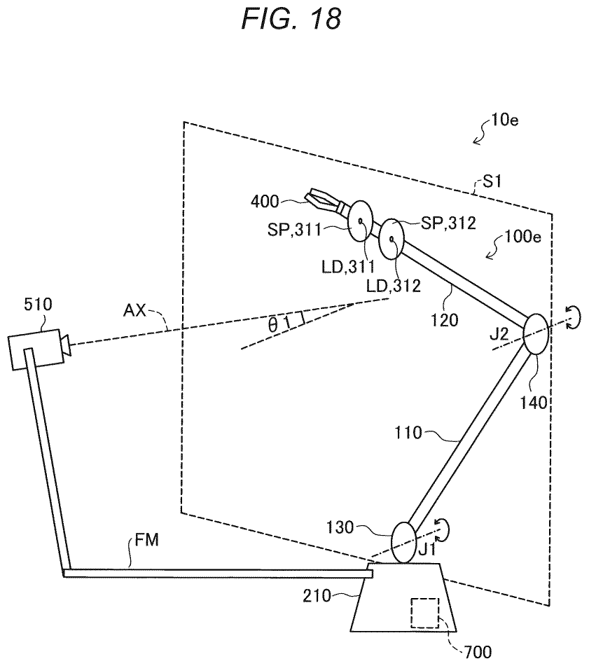

FIG. 18 is a diagram illustrating a schematic configuration of a robot system 10e according to a fifth embodiment. In the following explanation, components different from the components in the first embodiment are mainly explained and explanation is omitted about the same components as the components in the first embodiment.

The robot system 10e includes a robot 100e and the control unit 700. The robot 100e includes the first arm 110, the second arm 120, the joint section 130, the joint section 140, the base 210 that supports the first arm 110 and the second arm 120, a mark 311, a mark 312, the end effector 400, and the camera 510.

As a characteristic configuration in the present embodiment, the robot 100e includes two marks. The mark 311 and the mark 312 are configured the same as the mark 310 in the first embodiment. The mark 311 and the mark 312 are attached near an end portion of the second arm 120 on a side where the end effector 400 is attached. The mark 312 is disposed at a position farther from the end effector 400 compared with a position where the mark 311 is disposed.

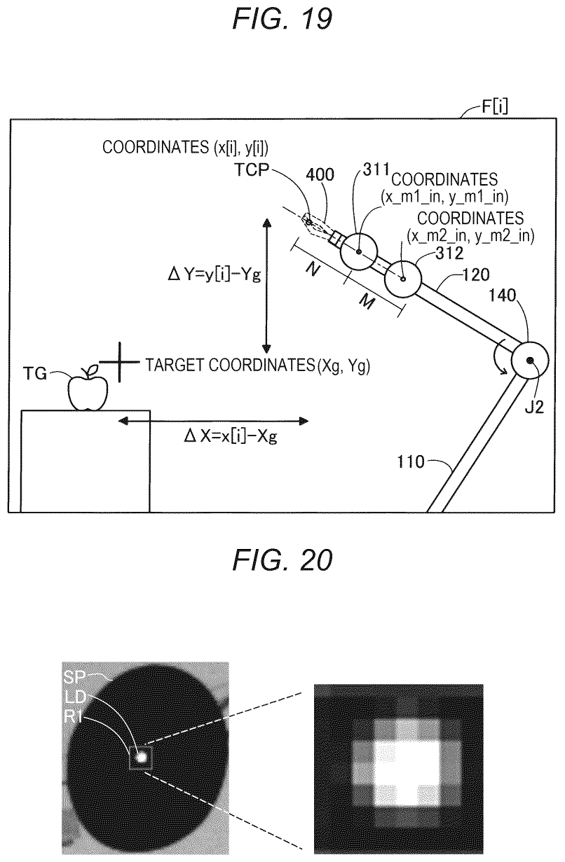

FIG. 19 is a diagram illustrating an example of the image F[i] captured by the camera 510. The mark 311 and the mark 312 are provided to determine a control point TCP of the robot 100e. In the present embodiment, the control point TCP of the robot 100e is set at a position to which a straight line connecting the center of the mark 311 and the center of the mark 312 is extended. The mark 311 and the mark 312 are disposed such that the control point TCP of the robot 100e, the center of the mark 311, and the center of the mark 312 are located on the same straight line. The distance between the center of the mark 311 closer to the control point TCP and the control point TCP of the robot 100e is represented as N and the distance between the center of the mark 311 and the center of the mark 312 is represented as M. The distances M and N are assumed to be known. A positional relationship between the mark 311, the mark 312, and the control point TCP and the camera 510 in the depth direction when viewed from the camera 510 is assumed to be adjusted as appropriate.

In the present embodiment, the control unit 700 can easily calculate coordinates (x[i], y[i]) of the control point TCP in the image F[i] as follows using coordinates (x_m1, y_m1) of the center of the mark 311 and coordinates (x_m2, y_m2) of the center of the mark 312 in the image F[i].

$$x [ i ] = x\_m1 [ i ] + ( x\_m1 [ i ] - x\_m2 [ i ] ) \times N / M$$

$$y [ i ] = y\_m1 [ i ] + ( y\_m1 [ i ] - y\_m2 [ i ] ) \times N / M$$

As explained above, in the present embodiment, the coordinates (x[i], y[i]) of the control point TCP can be easily obtained based on the coordinates (x_m1 [i], y_m1 [i]) of the center of the mark 311 and the coordinates (x_m2 [i], y_m2 [i]) of the center of the mark 312 in the image F[i].

In the first embodiment, an example is explained in which the mark 310 is disposed at the position close to the control point to the extent that the position of the mark 310 can be regarded the same as the position of the control point of the robot 100. However, since the light blocking plate SP is provided, the mark 310 has a certain degree of size. For this reason, when controlling an operation of the robot 100, it is necessary to designate a target point considering the distance between the position of the control point and the center position of the mark 310 as an offset. In order to set the offset to zero, it is also conceivable to directly dispose the mark 310 on the end effector 400. However, when the mark 310 is directly attached to the end effector 400, the mark 310 becomes an obstacle and the end effector 400 cannot be visually recognized. In the present embodiment, the position of the control point is specified using two physical markers attached to the second arm 120 and a known distance between one of the two markers and the control point. Thus, it is possible to dispose the two markers at positions away from the end effector 400.

### E2. Modification 1

FIG. 20 is a diagram concerning an algorithm for detecting coordinates in the image F[i] of the light emitting section LD. A left part of FIG. 20 is a portion in which the mark 311 or the mark 312 in the captured image F[i] is extracted. In order to facilitate understanding of the technique, it is assumed that a luminance value of the portions of the light emitting sections LD of the mark 311 and the mark 312 is the highest in the image F[i]. For the image F[i], gaze regions R1 and R2, which are fixed regions including the light emitting sections LD, are respectively set based on luminance values of pixels. The gaze regions R1 and R2 have a size of, for example, 8×8 pixels and are movable in the image F[i]. A right part of FIG. 20 illustrates the gaze region R1 or R2 having the size of 8×8 pixels.

Here, as an initial state, it is assumed that the marks are present in the respective gaze regions. The control unit 700 calculates a luminance centroid that is a center of gravity of luminance values of the pixels in the gaze region R1. In an image F[i+1] received next, the control unit 700 continuously captures the mark 311 by shifting coordinates of the gaze region R1 such that the luminance centroid is located at the center of the gaze region R1. The same applies to capturing of the mark 312. Coordinates of the marks are obtained by adding up coordinates of the gaze regions and luminance centroid coordinates in the gaze regions. In the method explained above, since a calculation target can be limited to the gaze regions R1 and R2, a load of processing of capturing the mark 311 and the mark 312 can be reduced. However, when an apparent size of the marks is not constant with respect to the size of the gaze regions R1 and R2, an error occurs in a calculation result and the control unit 700 fails in the capturing. Since the size of the gaze regions R1 and R2 is constant, it is necessary to keep an apparent size of the light emitting sections LD on an image F constant.

However, when the first arm 110 and the second arm 120 of the robot 100e move, the distance between the control point TCP and the camera 510 changes. Therefore, when the light emission intensity of the light emitting sections LD of the mark 311 and the mark 312 is constant, the apparent size of the mark 311 and the mark 312 in the captured image F[i] always fluctuates.

Thus, the control unit 700 adjusts the light emission intensity of the light emitting sections LD such that the apparent size of the mark 311 and the mark 312 in the captured image F[i] falls within a predetermined range. The light emission intensity of the LED configuring the light emitting section LD is proportional to an electric current flowing to the LED. As the distance between the mark 311 and the mark 312 and the camera 510 increases, the control unit 700 may intensify an electric current fed to the light emitting sections LD of the mark 311 and the mark 312 to increase the light emission intensity of the light emitting sections LD. The light emission intensity of the LED is proportional to a time in which the electric current flows. As the distance between the camera 510 and the mark 311 and the mark 312 increases, the control unit 700 may increase a time in which the electric current is fed to the light emitting sections LD of the marks 311 and 312 to increase the light emission intensity of the light emitting sections LD. Alternatively, an exposure time of the camera 510 may be extended in order to increase the intensity of light received by an imaging element of the camera 510. With the control explained above, even when the distance between the camera 510 and the mark 311 and the mark 312 increases, the size of the light emitting section LD of the mark 311 in a captured image can be kept constant.

### E3. Modification 2

The robot 100e may include the rotation mechanism 220 and the camera 520 explained in the second embodiment. With the configuration explained above, the moving ranges of the first arm 110 and the second arm 120 can be expanded to a three-dimensional space.

The robot 100e may include the lifting and lowering mechanism 230 explained in the third embodiment. In this case, the rotation mechanism 220 and the base 210 may be disposed on the lifting and lowering mechanism 230 or the lifting and lowering mechanism 230 may be disposed on the rotation mechanism 220 and the base 210 may be disposed on the lifting and lowering mechanism 230. With the configuration explained above, it is possible to move the first arm 110 and the second arm 120 in the up-down direction after expanding the moving ranges of the first arm 110 and the second arm 120 to a three-dimensional space.

As in the second embodiment, the robot 100e may include the first guide light irradiation unit 610, the second guide light irradiation unit 620, and the camera 530.

As in the fourth embodiment, the robot system 10e may include the traveling mechanism 240, the camera 540, and the plurality of cameras 550.

### F. SIXTH EMBODIMENT

### F1. Basic Configuration

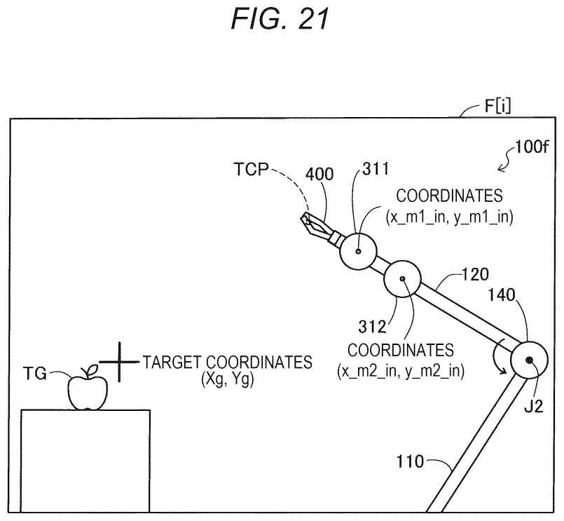

FIG. 21 is a diagram illustrating an example of the image F[i] obtained by the camera 510 imaging a robot 100f according to a sixth embodiment. The robot 100f includes the same components as the components of the robot 100e according to the fifth embodiment. In the fifth embodiment, the method of calculating the coordinates of the control point TCP in the image based on the coordinates of the centers of the two marks in the image is explained. In the present disclosure, an operation of the robot 100f is controlled based on the differences between coordinates of a control point and target coordinates.

In E2. Modification 1 of the fifth embodiment, as the method of calculating the coordinates of the marks, it is explained that the gaze regions R1 and R2 are provided, the marks are continuously captured by feeding back the coordinates of the gaze regions such that the luminance centroids in the gaze regions are the centers of the gaze regions, and the coordinates of the gaze regions at that time and the luminance centroids in the gaze regions are added up. In this method, at least the luminance centroids of the gaze regions and the marks need to overlap in the initial state. Thus, it is necessary to accurately calculate initial coordinate values of the mark 311 and the mark 312 with some other method. A method of accurately calculating initial values of coordinates of the mark 311 and initial values of coordinates of the mark 312 is explained below.

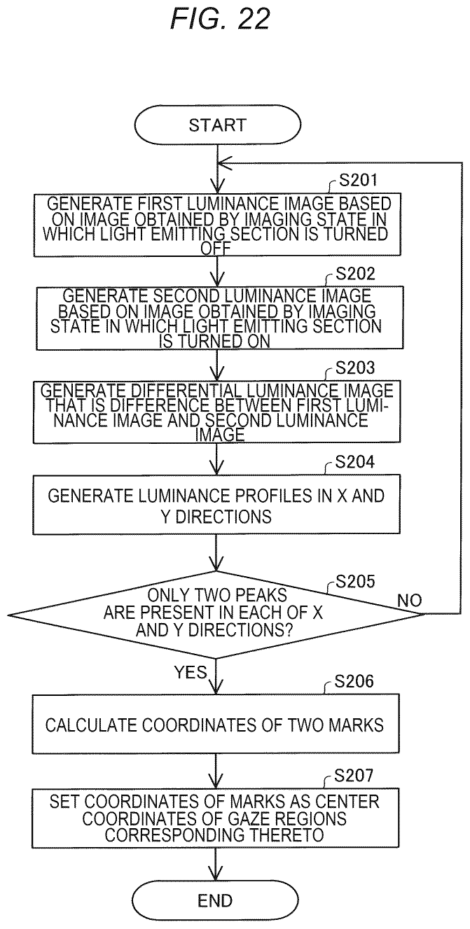

FIG. 22 is a flowchart of processing for specifying initial positions of the mark 311 and the mark 312. The processing illustrated in FIG. 22 is executed before the processing illustrated in FIGS. 4 and 5 is started. While the following processing is executed, the robot 100f needs to be stopped.

In step S201, the control unit 700 generates a first luminance image based on the image F[i] obtained by the camera 510 imaging a state in which the light emitting sections LD of the mark 311 and the mark 312 are turned off. Specifically, first, the control unit 700 controls the light emitting sections LD of the mark 311 and the mark 312 to be turned off. Further, the control unit 700 causes the camera 510 to execute imaging. The control unit 700 generates a luminance image based on the image F[i] supplied from the camera 510. The luminance image means an image including only brightness information. When the image F[i] supplied from the camera 510 is an RGB image, the control unit 700 calculates luminance values using RGB values of pixels of the image F[i] and a known calculation formula and generates a first luminance image LI1 representing the luminance value for each of the pixels.

In step S202, the control unit 700 generates a second luminance image based on an image obtained by capturing a state in which the light emitting sections LD of the mark 311 and the mark 312 are turned on. Specifically, first, the control unit 700 controls the light emitting sections LD of the mark 311 and the mark 312 to be turned on. Further, the control unit 700 causes the camera 510 to execute imaging. The control unit 700 generates a luminance image based on the image F[i+1] supplied from the camera 510. As in step S201, the control unit 700 calculates luminance values using RGB values of pixels of the image F[i+1] and the known calculation formula and generates a second luminance image LI2 representing the luminance value for each of the pixels.

In step S203, the control unit 700 generates a differential luminance image LI3 that is the difference between the first luminance image LI1 and the second luminance image LI2. Specifically, the control unit 700 calculates, for each of the pixels, the difference between a luminance value of the first luminance image LI1 and a luminance value of the second luminance image LI2 and generates the differential luminance image LI3 representing the luminance value difference for each of the pixels. Further, the control unit 700 executes image filter processing on the differential luminance image LI3. The image filter processing includes, for example, filter processing for noise removal and filter processing for binarization.

In step S204, the control unit 700 creates a luminance profile in the X-axis direction and a luminance profile in the Y-axis direction based on the differential luminance image LI3 subjected to the filter processing. The luminance profile in the X-axis direction is a luminance profile obtained by totaling luminance values of pixels at the same X coordinate in the Y-axis direction of the differential luminance image LI3. The luminance profile in the X-axis direction represents a one-dimensional distribution of luminance in the X-axis direction. The luminance profile in the Y-axis direction is a luminance profile obtained by totaling luminance values of pixels at the same Y coordinate in the X-axis direction of the differential luminance image LI3. The luminance profile in the Y-axis direction represents a one-dimensional distribution of luminance in the Y-axis direction.

In step S205, the control unit 700 discriminates whether only two peaks are present in the luminance profile in the X-axis direction and only two peaks are present in the luminance profile in the Y-axis direction. For example, the control unit 700 discriminates, as a peak, luminance equal to or higher than a predetermined threshold in the luminance profile in the X-axis direction. The same applies to the luminance profile in the Y-axis direction.

When only two peaks are present in the luminance profile in the X-axis direction and only two peaks are present in the luminance profile in the Y-axis direction (step S205; YES), the control unit 700 executes processing in step S206. On the other hand, when the condition explained above is not satisfied (step S205; NO), the control unit 700 executes the processing in step S201 and subsequent steps again.

In step S206, the control unit 700 calculates coordinate values of the mark 311 and the mark 312. Specifically, the control unit 700 sets, as an X coordinate x_m1_In of the center of the mark 311, an X coordinate of the peak having a smaller value of an X coordinate of the two peaks included in the luminance profile in the X-axis direction and sets, as an X coordinate x_m2_In of the center of the mark 312, an X coordinate of the peak having a larger value of an X coordinate of the two peaks. The control unit 700 sets, as a Y coordinate y_m1_In of the mark 311, a Y coordinate of the peak having a smaller value of a Y coordinate of the two peaks included in the luminance profile in the Y-axis direction and sets, as a Y coordinate y_m2_In of the mark 312, a Y coordinate of the peak having a larger value of the Y coordinate of the two peaks. It is assumed that a general positional relationship between the mark 311 and the mark 312 (see FIG. 21) is known.

In step S207, the control unit 700 sets the X coordinate x_m1_In and the Y coordinate y_m1_In of the mark 311 as the center coordinates of the gaze region R1 of the mark 311. Further, the control unit 700 sets the X coordinate x_m2_In and the Y coordinate y_m2_In of the mark 312 as the center coordinates of the gaze region R2 of the mark 312. The gaze regions are as explained in the fifth embodiment (see FIG. 20). Thereafter, the processing illustrated in FIG. 22 is ended.

As explained above, in the present embodiment, it is possible to easily specify the initial positions of the two marks in the image captured by the first camera. By accurately specifying the initial positions of the two marks, it is possible to correctly capture the two marks in images continuous captured in time series.

### F2. Modification 1

In an example illustrated in FIG. 22, assuming that the general positional relationship between the mark 311 and the mark 312 is known, the captured image in the state in which the mark 311 and the mark 312 are simultaneously turned on is acquired.

However, the general positional relationship between the mark 311 and the mark 312 is sometimes unknown. In such a case, the control unit 700 generates a first luminance image based on an image obtained by imaging a state in which the light emitting sections LD of the mark 311 and the mark 312 are turned off. The control unit 700 generates a fourth luminance image based on an image obtained by imaging a state in which only the mark 311 is turned on. The control unit 700 generates a fifth luminance image based on an image obtained by imaging a state in which only the mark 312 is turned on. The control unit 700 can calculate coordinates of the mark 311 based on the difference between the first luminance image and the fourth luminance image with the method explained above. The control unit 700 can calculate coordinates of the mark 312 based on the difference between the first luminance image and the fifth luminance image with the method explained above.

### F3. Modification 2

As in the second embodiment, the robot 100f may include the rotation mechanism 220 and the camera 520. The robot 100f may include the first guide light irradiation unit 610, the second guide light irradiation unit 620, and the camera 530.

As in the third embodiment, the robot 100f may include the lifting and lowering mechanism 230. As in the fourth embodiment, the traveling mechanism 240, the camera 540, and the plurality of cameras 550 may be provided in a robot system.

### G. SEVENTH EMBODIMENT

### G1: Basic Configuration

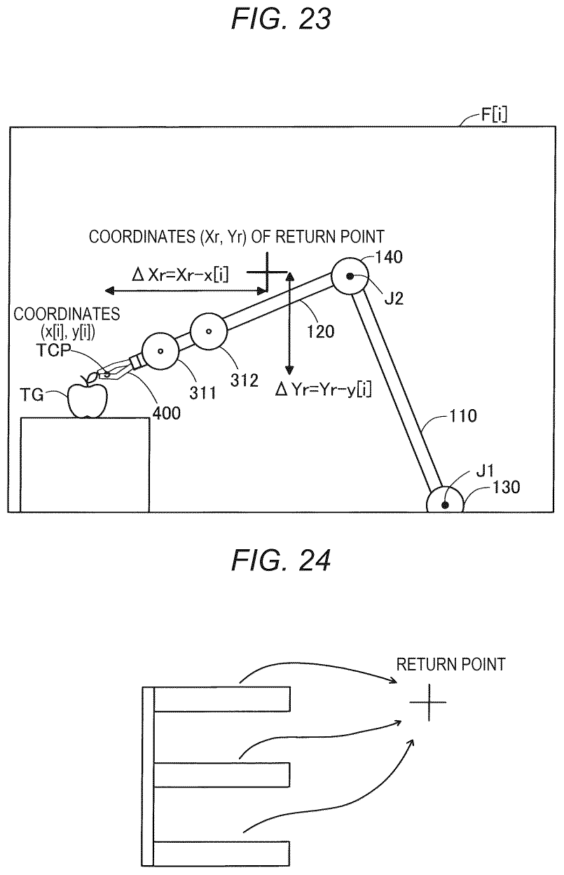

A robot system according to a seventh embodiment has the same configuration as the fifth embodiment (see FIG. 18). As a characteristic configuration of the present embodiment, when a preset condition is satisfied, the control unit 700 automatically executes control for returning the control point TCP of a robot to a preset return point. FIG. 23 is a diagram illustrating an example of coordinates of the return point. FIG. 24 is a diagram illustrating an operation of an arm. Here, an operation of placing a target on a shelf having three shelf plates is assumed. The return point is set as a point to which the control point TCP should return. Examples of the preset condition include a case in which the target TG is successfully gripped, a case in which release of the gripped target TG is completed, and a case in which a user explicitly issues a return instruction. The control of returning the control point TCP to the return point is to automatically indicate coordinates of the return point in advance as new target coordinates. The operation after the new target coordinates is indicated is the same as the operation in the first embodiment.

In the present embodiment, control for returning the control point to the return point is performed under a preset condition. In an aspect in which the control point is not returned to the return point, the control point is moved from a current position such as a target point designated immediately before to a new target point. For this reason, it could occur that a robot repeats an unreasonable posture and an operation of the robot is wasted. In an aspect in which the control point is automatically returned to the return point, the occurrence of such a problem can be suppressed.

### H. EIGHTH EMBODIMENT

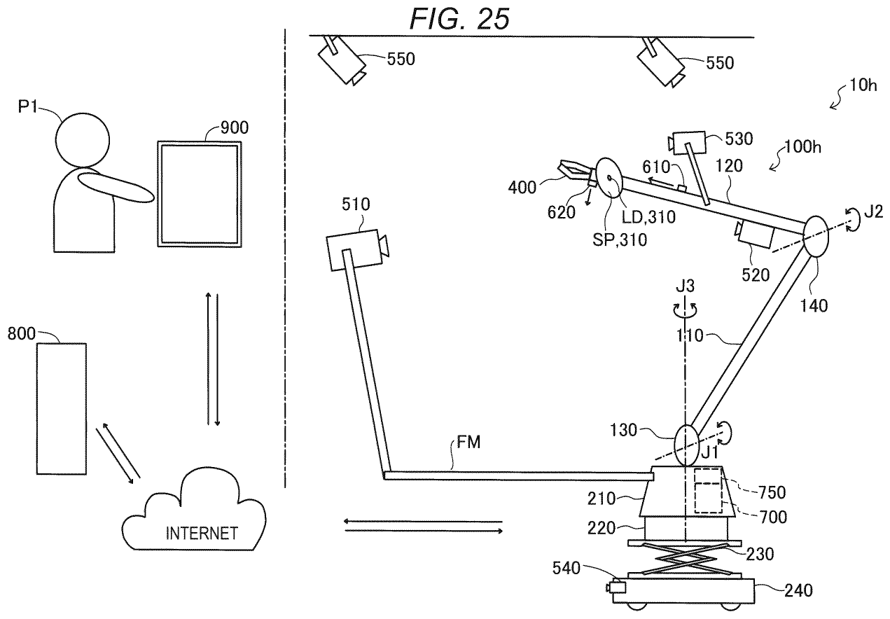

FIG. 25 is a diagram illustrating a schematic configuration of a robot system 10h according to an eighth embodiment. In the following explanation, components different from the components in the first embodiment are mainly explained and explanation is omitted about the same components as the components in the first embodiment.

The robot system 10h includes a robot 100h, the plurality of cameras 550, the control unit 700, the relay unit 750, a server 800, and the terminal device 900. The robot 100h includes the same components as the components in the robot 100d explained in the fourth embodiment. Hereinafter, explanation is omitted about the same components as the components in the fourth embodiment.

A configuration of the plurality of cameras 550 is the same as the configuration in the fourth embodiment. An image captured by the camera 550 is referred to as image F5[n]. A subscript n is a positive integer that is added up every time imaging is executed.

A configuration of the control unit 700 is the same as the configuration in the fourth embodiment. The control unit 700 transmits captured images and various data indicating a state of the robot 100h to the server 800 via the relay unit 750. The images transmitted to the server 800 include images captured by the cameras 510, 520, 530, 540, and 550.

The relay unit 750 transmits the images F5[n] received from the plurality of cameras 550 to the control unit 700. The relay unit 750 is, for example, a Wi-Fi router capable of accessing the Internet communication network. The relay unit 750 is capable of communicating with the control unit 700 by wired communication or wireless communication. The relay unit 750 is capable of communicating with the server 800 via the Internet communication network. Although an example in which the relay unit 750 is mounted on the robot 100h is illustrated in FIG. 25, the relay unit 750 may be disposed in a place different from the robot 100h. The relay unit 750 transmits a captured image received from the control unit 700 to the server 800. The relay unit 750 transmits information such as an operation instruction for the robot 100h and coordinates of a target point received from the server 800 to the control unit 700.

The server 800 generates an image representing an operation UI using the captured image received from the control unit 700 via the relay unit 750. The server 800 transmits the image representing the generated operation UI to the terminal device 900. The server 800 transmits information such as an operation instruction for the robot 100h and coordinates of a target point received from the terminal device 900 to the control unit 700.

The terminal device 900 may be any device including at least an Internet communication function, a pointing device, and a display. The terminal device 900 is, for example, a smartphone or a tablet including a touch panel display or a PC operated by a mouse. The mouse may be connected to the smartphone or the tablet. The terminal device 900 displays the image representing the operation UI received from the server 800. The terminal device 900 and the server 800 are also referred to as “display unit”. The terminal device 900 transmits, to the server 800, information such as an operation instruction for the robot 100h indicated by an operation instruction of a user P1 on the operation UI and coordinates of a target point. The terminal device 900 and the server 800 are also referred to as “input reception unit”.

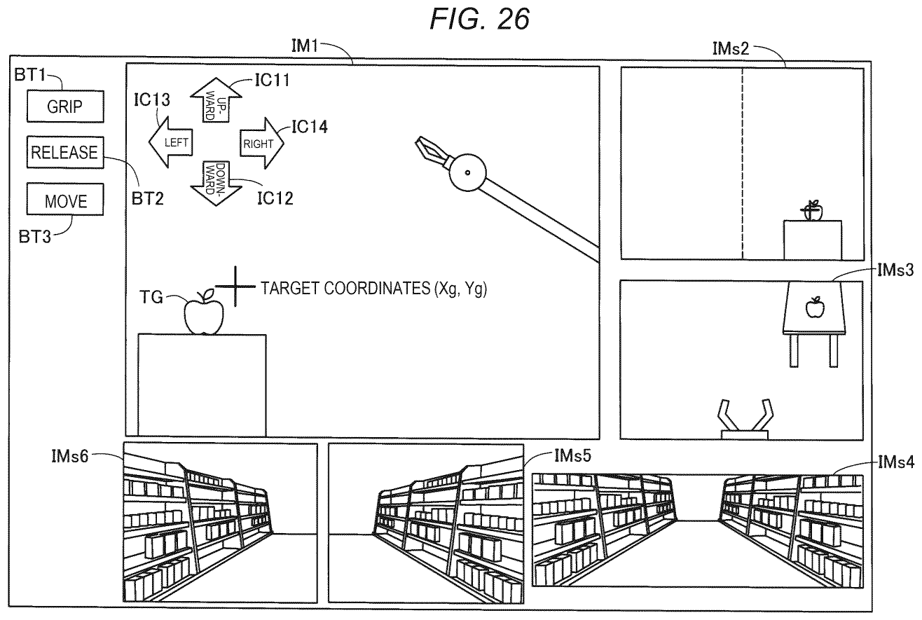

FIG. 26 is a diagram illustrating an example of the operation UI displayed on the terminal device 900. As illustrated in FIG. 26, in the operation UI, an image IM1 captured by the camera 510, an image IMs2 captured by the camera 520, an image IMs3 captured by the camera 530, an image IMs4 captured by the camera 540, and images IMs5 and IMs6 captured by the plurality of cameras 550 are simultaneously displayed.

In the example illustrated in FIG. 26, the image captured by the camera 510 is displayed as a main image. The main image is an image displayed in a state in which an operation instruction can be received. The main image is displayed larger than the other images. In the illustrated example, the main image is displayed at the upper left of a screen. The user P1 can cause the robot 100h to operate with pointing operation for the image selected as the main image. The control unit 700 controls an operation of the robot 100h in response to the pointing operation for the image IM1. The operation instruction for the image IM1 serving as the main image is also referred to as “first screen operation instruction”. The pointing operation is also referred to as “operation instruction”.

For example, the user P1 can indicate new target coordinates by performing pointing operation on a desired position of a main screen. The robot 100h controls an operation of an arm such that the control unit coincides with the target coordinates as in the first embodiment.

As illustrated, a plurality of virtual buttons may be displayed on the screen. For example, when an upward arrow icon IC11, a downward arrow icon IC12, a leftward arrow icon IC13, and a rightward arrow icon IC14 are displayed and the user P1 performs pointing operation on any one of the icon IC11, the icon IC12, the icon IC13, and the icon IC14, the target coordinates move upward, downward, left, and right directions by the number of pixels set in advance. The user P1 can easily finely adjust the target coordinates.

When the user P1 presses a “grip” virtual button BT1, the control unit 700 causes the end effector 400 to execute a gripping operation in response to an operation instruction of the user P1. When the user P1 presses a “release” virtual button BT2, the control unit 700 causes the end effector 400 to execute a releasing operation in response to an operation instruction of the user P1. The virtual buttons are particularly useful for a user who is not skilled in operation concerning a robot operation.

An instruction to the robot or the like can be allocated to each kind of operation such as click of a sub-button of a mouse, a mouse gesture, mouse wheel operation, a touch swipe on a screen, a touch long press, a multi-finger touch, and a multi-finger swipe besides the virtual buttons. Target instructions are, for example, fine movement of the target coordinates, rotation of the rotation shaft J3, and opening and closing of a gripping unit. By using the operation using the mouse and the touch operation on the screen explained above, a user skilled in operation concerning a robot operation can improve work efficiency. Association between the respective kinds of operation and the instructions to the robot or the like may be customized by the user.

In the operation UI illustrated in FIG. 26, the user P1 can instruct switching of the main image with pointing operation on any one of the images IMs2 to IMs6 serving as sub-images. In this case, the terminal device 900 transmits information indicating that the main image has been switched and information specifying the selected image to the server 800. The server 800 supplies an image representing an operation UI in which the selected image is set as the main image to the terminal device 900. Alternatively, the user P1 may instruct the switching of the main image by superimposing a mouse pointer on any one of the images IMs2 to IMs6 serving as the sub-images.

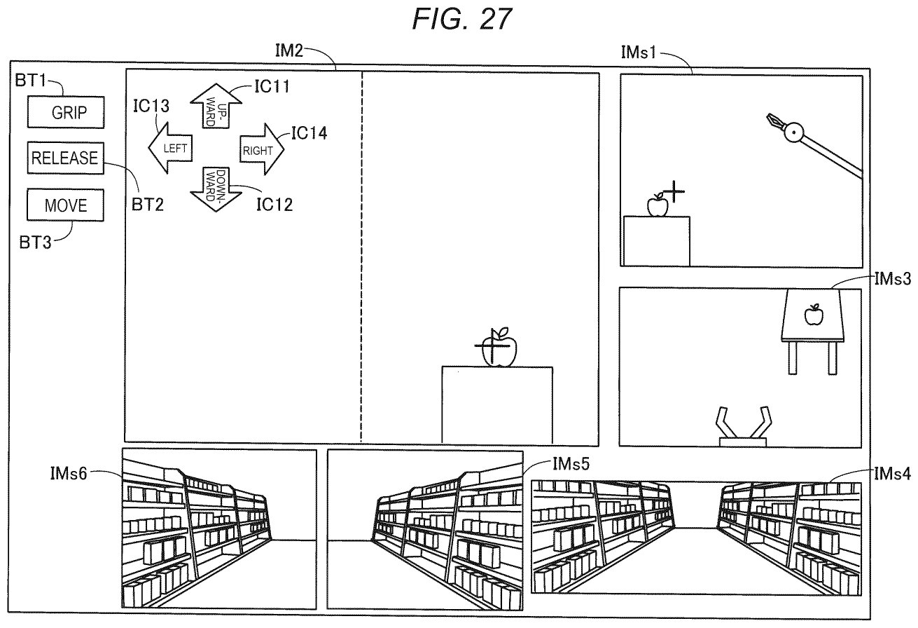

FIG. 27 is a diagram illustrating another example of the operation UI displayed on the terminal device 900. In the example illustrated in FIG. 27, an image IM2 captured by the camera 520 is displayed as a main image. For example, when the user P1 executes pointing operation of selecting the image IMs2 in the state illustrated in FIG. 26, the main image is switched and the state transitions to a state illustrated in FIG. 27. When an image captured by any one of the cameras is selected as the main image, the terminal device 900 and the server 800 functioning as the input reception unit can receive an operation instruction for the main image and a switching instruction to select any one of the sub-images as the main image. An aspect in which the selected image is displayed as the main image is not limited to the examples illustrated in FIGS. 26 and 27. For example, the image selected as the main image may be enlarged and displayed at the position of the image. That is, the selected image is displayed to be overlaid on another image. In this case, when operation of moving the mouse pointer out of a display range of the main image is performed, for example, a default image may be returned to a state of being displayed as the main image. The images IM1 to IMs6 do not always have the same aspect ratio but, by displaying the selected main image to be overlaid, no extra blank occurs on a displayed screen.

As illustrated in FIG. 27, when the image IM2 captured by the camera 520 is displayed as the main image, the user P1 can operate the direction of the arm by rotating the rotation shaft J3 as explained in the second embodiment. An operation instruction for the image IM2 displayed as the main image is also referred to as “second screen operation instruction”.

When the user P1 issues a predetermined operation instruction, the control unit 700 may execute processing in a movement mode. For example, the control unit 700 may start the execution of the processing in the movement mode in response to the user P1 executing pointing operation of selecting the image IMs4. In this case, although not illustrated, the selected image IMs4 may be displayed as the main image. The upward arrow icon IC11, the downward arrow icon IC12, the leftward arrow icon IC13, and the rightward arrow icon IC14 are superimposed and displayed on the image IMs4 serving as the main image. In the movement mode, as explained in the fourth embodiment, the traveling of the traveling mechanism 240 is controlled. When the user P1 performs pointing operation on any one of the icon IC11, the icon IC12, the icon IC13, and the icon IC14, the traveling mechanism 240 can be moved forward or backward or turned left or turned right. Alternatively, the traveling mechanism 240 can be caused to operate by a mouse gesture, a swipe of a touch panel, or the like. When an operation instruction to laterally scroll a tilt wheel of a mouse is issued, the control unit 700 can cause the traveling mechanism 240 to perform spin turn. When an operation instruction to vertically scroll the tilt wheel of the mouse is issued, the control unit 700 can move the traveling mechanism 240 forward. An operation instruction for the image IMs4 displayed as the main image is also referred to as “fourth screen operation instruction”. An operation instruction for the image IMs3 displayed as the main image is also referred to as “third screen operation instruction”.

The control unit 700 may start the execution of the processing in the movement mode in response to the user P1 executing pointing operation of selecting the image IMs5 or the image IMs6. In this case, although not illustrated, the selected image IMs5 or IMs6 may be displayed as the main image. The upward arrow icon IC11, the downward arrow icon IC12, the leftward arrow icon IC13, and the rightward arrow icon IC14 are superimposed and displayed on the image IMs5 or the image IMs6 serving as the main image. In the movement mode, the traveling of the traveling mechanism 240 is controlled as explained in the fourth embodiment. While checking the image IMs5 or the image IMs6 captured by the camera 550, for example, the user P1 performs pointing operation on the icons IC11 to IC14 to move the traveling mechanism 240 forward and backward and turn the traveling mechanism 240 in order to move the robot 100h to a desired place.

A position marker for identifying the position of the traveling mechanism 240 may be provided in the traveling mechanism 240. It is assumed that the control unit 700 has a function of detecting the position marker based on the image IMs5 or the image IMs6 captured by the camera 550. When the user designates a target point, the control unit 700 controls, using the object tracking algorithm, the traveling mechanism 240 to move to the designated target point. In this case, the user does not need to sequentially issue instructions relating to traveling. The user can move the robot 100h to a desired place only by designating a desired position on an image as a target point with pointing operation. Every time the camera 550 acquires an image F5, the control unit 700 controls the traveling of the traveling mechanism 240 using the visual servoing to reduce the differences between coordinates indicating a position marker in the image F5 and coordinates indicating the designated target point. When the coordinates indicating the position marker and the coordinates indicating the target point coincide in the image F5, the robot 100h reaches the target point.

A virtual button for emergency stop of the robot 100h may be provided in the operation UI. When pointing operation is performed on the virtual button for the emergency stop or the mouse pointer is placed on the virtual button for the emergency stop, an electric current supplied to the robot 100h is interrupted. Alternatively, the electric current supplied to the robot 100h may be interrupted in response to operation of the user P1 tapping the operation UI a plurality of times with a finger.

In the present embodiment, the terminal device 900 and the server 800 can receive an operation instruction using an image selected out of images captured by the cameras 510 to 550. Thus, the user P1 can check a relationship between the control point and the target point while checking different visual points and can issue an operation instruction. Further, the terminal device 900 and the server 800 can receive the operation instruction using one image selected out of the images captured by the cameras 510 to 550. Thus, the user P1 can issue the operation instruction while checking the different visual points.

The present disclosure is not limited to the embodiments explained above and can be implemented with various configurations without departing from the gist of the present disclosure. For example, technical features in the embodiments corresponding to technical features in the aspects described in the summary of the disclosure can be replaced or combined as appropriate in order to solve some or all of the problems described above or to achieve some or all of the effects described above. If the technical features are not explained as essential technical features in the present specification, the technical features can be deleted as appropriate.

### I. OTHER ASPECTS

(1) According to an aspect of the present disclosure, a robot is provided. The robot includes: a base; a first arm coupled to the base and configured to rotate around a first rotation shaft; a second arm coupled to one end portion of the first arm and configured to rotate around a second rotation shaft parallel to the first rotation shaft with respect to the first arm; at least one physical marker attached to the second arm in order to determine a control point of the robot; a first camera, a position and a posture of which are fixed with respect to the base, the first camera being disposed at a position where, when a virtual plane orthogonal to the first rotation shaft is assumed, the first camera can image the marker that moves on the virtual plane and imaging the first arm and the second arm at a fixed time interval; and a control unit configured to determine, every time the first camera acquires an image, based on differences between coordinate values of the control point of the robot determined from the marker in the image captured by the first camera and coordinate values of a designated target point, a displacement amount of rotation of a first motor that rotates the first arm around the first rotation shaft and a displacement amount of rotation of a second motor that rotates the second arm around the second rotation shaft and control the first motor and the second motor to rotate with the determined displacement amounts.

According to the aspect described above, the control of rotating the first motor that rotates the first rotation shaft or the second motor that rotates the second rotation shaft by the displacement amount determined based on the differences between the coordinate values of the control point of the robot and the coordinate values of the designated target point in the image is performed. According to this aspect, it is unnecessary to execute processing with a heavy load such as coordinate conversion as in the related art. Thus, a processing load of robot control can be reduced.
(2) The robot according to the aspect described above may further include: a rotation mechanism configured to rotate the base around a third rotation shaft perpendicular to the first rotation shaft according to the control of the control unit; and a second camera configured to perform imaging in a moving direction of the second arm and fixed to the first arm or the second arm. The control unit may control, based on an image captured by the second camera, at least the rotation mechanism to direct the moving direction of the second arm to a direction of the designated target point and control the rotation mechanism not to rotate the first rotation shaft and the second rotation shaft while the rotation mechanism is rotating the base and not to rotate the base while the rotation mechanism is rotating at least one of the first rotation shaft and the second rotation shaft.

Since the first rotation shaft and the second rotation shaft are parallel to each other, an operation of the robot is limited to within a two-dimensional plane in an aspect in which the rotation mechanism is not provided. According to the aspect described above, since the base can be rotated around the third rotation shaft perpendicular to the first rotation shaft and the second rotation shaft, it is possible to expand moving ranges of the first arm and the second arm coupled to the base to a three-dimensional space.
(3) The robot according to the aspect described above may further include a first irradiation unit fixed to the second arm and configured to irradiate guide light in the moving direction of the second arm. The first camera may be disposed at a position where the first camera images a place irradiated with the guide light, and the control unit may present the image captured by the first camera and receive designation of a target point.

According to the aspect described above, the user can designate the target point after checking an image obtained by imaging the place irradiated with the guide light and checking a moving direction of the second arm in future represented by the guide light.
(4) The robot according to the aspect described above may further include: a gripping unit coupled to a distal end portion of the second arm; and a second irradiation unit that is a light source configured to irradiate, with light, a place having a predetermined positional relationship with respect to the gripping unit, and the first camera may be disposed at a position where the first camera images the light irradiated by the second irradiation unit.

According to the aspect described above, the user can easily discriminate, based on an image obtained by imaging the light irradiated on the place having the predetermined positional relationship with respect to the gripping unit, whether a placement table is present at the place irradiated with the light.
(5) The robot according to the aspect described above may further include a third camera configured to image the gripping unit.
(6) The robot according to the aspect described above may further include a lifting and lowering mechanism configured to lift and lower the base.

According to the aspect described above, the first arm and the second arm coupled to the base can be moved in the up-down direction by the lifting and lowering mechanism. Since the first camera rises and falls together with the base, even if the base rises and falls, the position and the posture of the first camera with respect to the virtual plane orthogonal to the first rotation shaft are maintained.
(7) The robot according to the aspect described above may further include a traveling mechanism configured to cause the base to travel. The traveling mechanism may include: a front camera configured to perform imaging in a moving direction of the traveling mechanism; and a traveling control unit configured to, when receiving a traveling instruction from the control unit, control the traveling of the traveling mechanism using an image captured by the front camera.

According to the aspect described above, the first arm and the second arm coupled to the base can be moved by the traveling mechanism.
(8) In the robot according to the aspect described above, the traveling control unit may control the traveling of the traveling mechanism using images captured by two or more external cameras disposed at positions where the external cameras perform imaging in a range in which the robot is assumed to travel.

According to the aspect described above, it is possible to perform highly accurate monitoring for traveling of the robot using the plurality of external cameras.
(9) The robot according to the aspect described above may further include a link mechanism configured to, by mechanically transmitting, to the second arm, at least a part of power output by a motor that drives the first rotation shaft, act in a direction for cancelling the rotation of the second arm caused by the rotation of the first arm.

In an aspect in which the link mechanism is not provided, for example, it is assumed that only the first rotation shaft is rotated without rotating the second rotation shaft. In this case, the posture of the second arm greatly changes in association with the rotation of the first arm. It is also conceivable to rotate the first rotation shaft and the second rotation shaft simultaneously or at a very short time interval such that the posture of the second arm does not greatly change in association with the rotation of the first arm. However, in this case, it is necessary to calculate a rotation amount of the first rotation shaft and a rotation amount of the second rotation shaft for offsetting displacement of the posture of the second arm due to the rotation of the first rotation shaft. When the link mechanism is provided, it is possible to reduce an amount of change in the posture of the second arm associated with the rotation of the first arm. Therefore, in order to reduce the differences between the coordinate values of the control point of the robot and the coordinate values of the target point in the image captured by the first camera, for example, it is only necessary to repeat rotating the first arm to reduce the difference between an X coordinate of the control point of the robot and an X coordinate of the target point and rotating the second arm to reduce the difference between a Y coordinate of the control point of the robot and a Y coordinate of the target point. Thus, according to the aspect described above, it is unnecessary to calculate the rotation amount of the first rotation shaft and the rotation amount of the second rotation shaft for offsetting the displacement of the posture of the second arm due to the rotation of the first rotation shaft.
(10) In the robot according to the aspect described above, the link mechanism may be configured to move the second arm in parallel in association with the rotation of the first arm.
(11) In the robot according to the aspect described above, the link mechanism may be configured to move the second arm in non-parallel in association with the rotation of the first arm.
(12) According to another aspect of the present disclosure, a robot is provided. The robot is a robot configured as a Cartesian coordinate robot and includes: at least one physical marker representing a position of a control point of the robot; a first slider configured to linearly move the control point along an X axis; a second slider configured to linearly move the control point along a Y axis orthogonal to the X axis; a first camera, a position and a posture of which are fixed with respect to the first slider and the second slider, the first camera being disposed at a position where, when a virtual plane parallel to the X axis and the Y axis is assumed, the first camera images the control point that moves on the virtual plane and imaging the first slider and the second slider at a fixed time interval; and a control unit configured to cause the first slider and the second slider to respectively operate to reduce differences between coordinate values of the control point of the robot and coordinate values representing a designated target point in an image captured by the first camera.

What is claimed is:

1. A robot comprising:
a base;
a first arm coupled to the base and configured to rotate around a first rotation shaft;
a second arm coupled to one end portion of the first arm and configured to rotate around a second rotation shaft parallel to the first rotation shaft with respect to the first arm;
at least one physical marker attached to the second arm in order to determine a control point of the robot;
a first camera, a position and a posture of which are fixed with respect to the base, the first camera being disposed at a position where, when a virtual plane orthogonal to the first rotation shaft is assumed, the first camera can image the marker that moves on the virtual plane and imaging the first arm and the second arm at a fixed time interval; and
a control unit configured to determine, every time the first camera acquires an image, based on differences between coordinate values of the control point of the robot determined from the marker in the image captured by the first camera and coordinate values of a designated target point, a displacement amount of rotation of a first motor that rotates the first arm around the first rotation shaft and a displacement amount of rotation of a second motor that rotates the second arm around the second rotation shaft and control the first motor and the second motor to rotate with the determined displacement amounts.

2. The robot according to claim 1, further comprising:
a rotation mechanism configured to rotate the base around a third rotation shaft perpendicular to the first rotation shaft according to the control of the control unit; and
a second camera configured to perform imaging in a moving direction of the second arm and fixed to the first arm or the second arm, wherein
the control unit controls, based on an image captured by the second camera, at least the rotation mechanism to direct the moving direction of the second arm to a direction of the designated target point and controls the rotation mechanism not to rotate the first rotation shaft and the second rotation shaft while the rotation mechanism is rotating the base and not to rotate the base while the rotation mechanism is rotating at least one of the first rotation shaft and the second rotation shaft.

3. The robot according to claim 2, further comprising a first irradiation unit fixed to the second arm and configured to irradiate guide light in the moving direction of the second arm, wherein
the first camera is disposed at a position where the first camera images a place irradiated with the guide light, and
the control unit presents the image captured by the first camera and receives designation of a target point.

4. The robot according to claim 3, further comprising:
a gripping unit coupled to a distal end portion of the second arm; and
a second irradiation unit that is a light source configured to irradiate, with light, a place having a predetermined positional relationship with respect to the gripping unit, wherein
the first camera is disposed at a position where the first camera images the light irradiated by the second irradiation unit.

5. The robot according to claim 4, further comprising a third camera configured to image the gripping unit.

6. The robot according to claim 5, further comprising a lifting and lowering mechanism configured to lift and lower the base.

7. The robot according to claim 6, further comprising a traveling mechanism configured to cause the base to travel, wherein
the traveling mechanism includes:
a front camera configured to perform imaging in a moving direction of the traveling mechanism; and
a traveling control unit configured to, when receiving a traveling instruction from the control unit, control the traveling of the traveling mechanism using an image captured by the front camera.

8. The robot according to claim 7, wherein the traveling control unit controls the traveling of the traveling mechanism using images captured by one or more external cameras disposed at positions where the external cameras perform imaging in a range in which the robot is assumed to travel.

9. The robot according to claim 1, further comprising a link mechanism configured to, by mechanically transmitting, to the second arm, at least a part of power output by a motor that drives the first rotation shaft, act in a direction for cancelling the rotation of the second arm caused by the rotation of the first arm.

10. The robot according to claim 9, wherein the link mechanism is configured to move the second arm in parallel in association with the rotation of the first arm.

11. The robot according to claim 9, wherein the link mechanism is configured to move the second arm in non-parallel in association with the rotation of the first arm.

12. A robot configured as a Cartesian coordinate robot, the robot comprising:
at least one physical marker representing a position of a control point of the robot;
a first slider configured to linearly move the control point along an X axis;
a second slider configured to linearly move the control point along a Y axis orthogonal to the X axis;
a first camera, a position and a posture of which are fixed with respect to the first slider and the second slider, the first camera being disposed at a position where, when a virtual plane parallel to the X axis and the Y axis is assumed, the first camera images the control point that moves on the virtual plane and imaging the first slider and the second slider at a fixed time interval; and
a control unit configured to cause the first slider and the second slider to respectively operate to reduce differences between coordinate values of the control point of the robot and coordinate values representing a designated target point in an image captured by the first camera.
